(19) United States
(12) Patent Application Publication
(10) Pub. No.: US 2024/0212240 A1
(43) Pub. Date: Jun. 27, 2024

(54) INTEGRATING OVERLAID CONTENT INTO DISPLAYED DATA VIA PROCESSING CIRCUITRY BY DETECTING THE PRESENCE OF A REFERENCE PATCH IN A FILE

(71) Applicant: MOBEUS INDUSTRIES, INC., Sparta, NJ (US)

(72) Inventor: Dharmendra ETWARU, Sparta, NJ (US)

(73) Assignee: MOBEUS INDUSTRIES, INC., Sparta, NJ (US)

(21) Appl. No.: 18/088,223

(22) Filed: Dec. 23, 2022

(51) Int. Cl. G06T 11/60; G06F 3/14

(52) U.S. Cl. CPC G06T 11/60; G06F 3/14

(57) ABSTRACT

An apparatus, method, and computer readable medium that include detecting, in data of a file, a reference patch that includes a unique identifier associated with an available area in which secondary content is insertable in displayed data that is to be displayed by a display when the reference patch is displayed, the unique identifier including first encoded data that identifies the secondary content, a location address of the secondary content, and a screen position within the available area at which the secondary content is insertable in the displayed data; and in response to detecting the reference patch, retrieving the secondary content based on the unique identifier, and after retrieving the secondary content and when the reference patch is displayed, overlaying the secondary content onto the displayed data in accordance with the available area and the screen position identified by the unique identifier.

### CROSS-REFERENCE TO RELATED APPLICATIONS

The present application is related to U.S. application Ser. No. 17/408,065, filed Aug. 20, 2021, and U.S. application Ser. No. 17/675,748, filed Feb. 18, 2022, the entire content of each of which is incorporated by reference herein in its entirety for all purposes.

### FIELD OF THE DISCLOSURE

The present disclosure relates to overlaying content into displayed data via graphics processing circuitry.

### DESCRIPTION OF THE RELATED ART

Displayed data has traditionally been presented within the bounds of a two-dimensional geometric screen. The visual experience of such displayed data is thus lacking in dynamism that allows for the layering of functionality within a given display frame.

The foregoing description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

Accordingly, the present disclosure provides methods for overlaying displayed data into displayed data and generating augmented visual experiences that are informative and interactive.

The present disclosure relates to an apparatus, including processing circuitry configured to detect, in data of a file, a reference patch that includes a unique identifier associated with an available area in which secondary content is insertable in displayed data that is to be displayed by the apparatus when the reference patch is displayed, the unique identifier including first encoded data that identifies the secondary content, a location address of the secondary content, and a screen position within the available area at which the secondary content is insertable in the displayed data and in response to detecting the reference patch, retrieve the secondary content based on the unique identifier, and after retrieving the secondary content and when the reference patch is displayed, overlay the secondary content onto the displayed data in accordance with the available area and the screen position identified by the unique identifier.

The present disclosure also relates to a method, including detecting, in data of a file, a reference patch that includes a unique identifier associated with an available area in which secondary content is insertable in displayed data that is to be displayed by a display when the reference patch is displayed, the unique identifier including first encoded data that identifies the secondary content, a location address of the secondary content, and a screen position within the available area at which the secondary content is insertable in the displayed data, and in response to detecting the reference patch, retrieving the secondary content based on the unique identifier, and after retrieving the secondary content and when the reference patch is displayed, overlaying the secondary content onto the displayed data in accordance with the available area and the screen position identified by the unique identifier.

The present disclosure also relates to a non-transitory computer-readable storage medium for storing computer-readable instructions that, when executed by a computer, cause the computer to perform a method, the method including detecting, in data of a file, a reference patch that includes a unique identifier associated with an available area in which secondary content is insertable in displayed data that is to be displayed by a display when the reference patch is displayed, the unique identifier including first encoded data that identifies the secondary content, a location address of the secondary content, and a screen position within the available area at which the secondary content is insertable in the displayed data, and in response to detecting the reference patch, retrieving the secondary content based on the unique identifier, and after retrieving the secondary content and when the reference patch is displayed, overlaying the secondary content onto the displayed data in accordance with the available area and the screen position identified by the unique identifier.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of user devices communicatively connected to a server, according to an exemplary embodiment of the present disclosure.

FIG. 2A is a flow chart for a method of generating a reference patch and embedding the reference patch into displayed data, according to an exemplary embodiment of the present disclosure.

FIG. 2B is a flow chart of a sub-method of generating the reference patch, according to an exemplary embodiment of the present disclosure.

FIG. 2C is a flow chart of a sub-method of associating the surface area with content, according to an exemplary embodiment of the present disclosure.

FIG. 2D is a flow chart of a sub-method of integrating the reference patch into the displayed data, according to an exemplary embodiment of the present disclosure.

FIG. 3A is a flow chart for a method of inspecting the reference patch, according to an exemplary embodiment of the present disclosure.

FIG. 3B is a flow chart of a sub-method of identifying the reference patch with unique identifiers corresponding to the surface area from the stream of data, according to an exemplary embodiment of the present disclosure.

FIG. 3C is a flow chart of a sub-method of associating the unique identifiers with content, according to an exemplary embodiment of the present disclosure.

FIG. 4A is a flow chart for a method of identifying the reference patch included in the displayed data and overlaying the content into displayed data, according to an exemplary embodiment of the present disclosure.

FIG. 4B is a flow chart of a sub-method of identifying the reference patch with the unique identifiers corresponding to the surface area from the stream of data, according to an exemplary embodiment of the present disclosure.

FIG. 4C is a flow chart of a sub-method of associating the unique identifiers with content, according to an exemplary embodiment of the present disclosure.

FIG. 5 is an example of transparent computing.

FIGS. 6A-6C depict an augmentation implemented in a slide deck, according to an exemplary embodiment of the present disclosure.

FIGS. 7A-7K depict an augmentation within a frame of a display, according to an exemplary embodiment of the present disclosure.

FIG. 7L is an illustration of an augmentation within a frame of a display, according to an exemplary embodiment of the present disclosure.

FIG. 8 is a flow chart of a method of detecting and utilizing an indicator present in a file data, according to an exemplary embodiment of the present disclosure.

FIG. 9 is a schematic of a user device for performing a method, according to an exemplary embodiment of the present disclosure.

FIG. 10 is a schematic of a hardware system for performing a method, according to an exemplary embodiment of the present disclosure.

FIG. 11 is a schematic of a hardware configuration of a device for performing a method, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

According to an embodiment, the present disclosure relates to augmentation of a digital user experience. The augmentation may include an overlaying of objects onto a viewable display area of a display of an electronic device. The electronic device may be a mobile device such as a smartphone, tablet, and the like, a desktop computer, or any other electronic device that displays information. The objects may include text, images, videos, and other graphical elements, among others. The objects may be interactive. The objects may be associated with third-party software vendors.

In order to realize the augmentation of a digital user experience, a reference patch, that is a region of interest acting as an anchor, can be used. In one embodiment, the reference patch or other visually detectable element may serve to indicate a position at which content is to be placed onto a display. In an embodiment and as described herein, the reference patch may include encoded information that may be used to retrieve content and place that content into a desired location or locations in displayed data. The reference patch can be embedded within displayed data (such as, but not limited to, an image, a video, a document, a webpage, or any other application that may be displayed by an electronic device). The reference patch can include unique identifying data, a marker, or encoding corresponding to predetermined content. Such content can be or include an image, a video, a document, a sound, a webpage, an application, or the like, or a combination of these. The reference patch can indicate to the electronic device the particular content that is to be displayed, the position at which the content is to be placed, and the size with which the content is to be displayed. Accordingly, when a portion of the displayed data including the reference patch is displayed in a current frame of displayed data, the corresponding augmentation can be overlaid on the current frame of the displayed data wherein the augmentation includes secondary content (i.e., content that is secondary to (or comes after) the primary displayed data), herein referred to as “content,” and/or objects. For example, an augmentation can include additional images to be displayed with the current frame of displayed data for a seamless visual experience.

The above-described augmentation, however, can be computationally intensive or can be slow. Any delay in providing the secondary content can create a poor experience for a user. Intense use of computer resources, such as memory, processing, or network bandwidth can also lead to degradation of performance of the computer not only associated with the displayed data or secondary content, but with other processes or factors as well. Continually scanning for, detecting, tracking, or otherwise monitoring the reference patch without prior knowledge can be very resource intensive. Further, always attempting to find such a reference patch when one may not even be present represents an inefficient use of those resources. Computational resources could be “wasted” on looking for a reference patch which is not present or duplicating processes which do not need to be performed more than once. Providing information which indicates the presence of a reference patch can be advantageous for targeting the use of such computer resources so as to improve performance. Any additional information regarding the reference patch would be of further advantage for furthering such conservation. For example, if, before or when opening a file, it could be known that a reference patch is present, such computer resources could be harnessed only when such a file is open. Further, if additional information related to the reference patch was available, additional targeting could narrow the scope of the usage of resources to further improve performance.

The file can be any suitable type of computer resource for recording data in a computer storage device. Examples of files include, but are not limited to, word processing document files (i.e., DOC/DOCX) provided by e.g., Microsoft® Word, Portable Document Format (PDF) files such as the ones used by Adobe Acrobat®, in a Microsoft® PowerPoint presentations (PPT/PPTX), or video sequence files such as MPEG, MOV, AVI or the like. Data of a file can be or include, for example, the contents of the file such as the text and/or images or a document, the text, images, videos, and/or animations of a presentation, images and/or audio of a video file, and/or metadata. Metadata refers to data other than the contents of the file described above that provides information about that other data. Metadata can be any suitable type of data or provide any suitable type of information about the file and/or the data of the file. Examples of types of metadata include, but are not limited to, descriptive metadata which provides information about the identity of the file such as author/creator, filename, file size, or a file identification number, structural metadata which provides information on how the data of the file is organized, such as which text/images to include on which slide or page, the order of the slides or pages, the data structures used to save the data in the storage device, and the like, and administrative metadata which provides information related to the management of the file such as file type, permission, creation date, edit date, last access date, and the like.

For example, consider a slide deck. Such a slide deck may have a reference patch. Without any additional information, the entirety of a displayed data would have to be continuously monitored to detect the reference patch. Prior knowledge that the reference patch is in the slide deck, however, allows avoiding having to monitor display data for the reference patch when the slide deck is not open or when the slide deck is not displayed (e.g., minimized or obscured by other displayed data such as windows). The monitoring could be limited to only the region of the display data which corresponds to the slide deck. For example, monitoring can be initiated only when the slide deck is opened, halted if the slide deck is no longer displayed (e.g., minimized or obscured by other displayed data such as windows), or only performed in the region of the display in which the slide deck is located. Further, if information were available as to the location of the reference patch within the slide deck (e.g., only on slide 5), such monitoring may be halted or avoided on every slide except slide 5, where the reference patch is known to be located.

The presence of a reference patch can be detected in the data of a file. For example, the data of a file can be scanned, inspected, or otherwise assessed in a manner which does not open and display the contents of the file. The presence of the reference patch can be identified by a suitable attribute or combination of attributes of the data. Information encoded in the reference patch does not need to be decoded for the presence of the reference patch to be detected. If additional information relating to the secondary content associated with that reference patch, for example the location of the secondary content at a remote device, were available, performance could be improved by accessing and readying the secondary content in anticipation that the reference patch will be displayed. Such additional information can be detected in the reference patch itself, data related to the reference patch, or in an indicator, such as a flag, a register, a designated bit, or other types of indicators located in the data of the file or data associated with the file. For example, instead of waiting to retrieve the secondary content from a remote device after detecting the reference patch and then displaying the augmentation after detecting the reference patch, the use of the indicator would result in the retrieval of the secondary content upon opening the slide deck, to be used in the augmentation upon detection of the reference patch in the displayed data. Such pre-retrieval can save computational resources during a critical time in the use of the slide deck and can provide a much faster generation and/or display of the augmentation containing the secondary content as no remote device must be accessed when the reference patch is first displayed. Pre-retrieval can provide an advantage where the secondary content is retrieved and ready for displaying immediately when the file is opened. Additionally or alternatively, the secondary content can be displayed without delay when the reference patch is detected. This may be of particular advantage in situations where the display data is dynamic, such as video or a teleconference. Removing delay related to searching a larger area for the detection of the reference patch or in relation to retrieving the secondary content can be critical to generating seamless experiences for users. Further, such pre-retrieval could allow for the display of such secondary content even in the absence of a network connection to the remote device.

It is clear that such advance knowledge of the presence and/or details of the reference patch represent a distinct advantage. The present disclosure provides such advance knowledge through the use of detection of presence of the reference patch by inspection of the file data. The use of data, such as metadata which is capable of being accessed or read without having to open a file, can provide the specific advantages discussed above and further discussed below.

The above-described augmentations are particularly relevant to environments where the underlying content is static. Static content may include textual documents or slide decks. Often, the static content is stored locally in the electronic device, e.g., in a memory location integral with or connected directly to the electronic device such as a main memory, a GPU, a CPU, a hard drive, a solid state drive, flash memory, and the like. Due to its nature, the static content is not capable of being dynamically adjusted according to complex user interactions, in real-time, during a user experience. Such a digital user experience is cumbersome and inefficient. Thus, a heightened, augmented user experience is desired to provide increased convenience, engagement, and agility. The augmentations described herein reduce cumbrousness by providing a visual representation/aid of retrieved external content, and provide improved engagement of the user, agility of navigation through the displayed data, and overall performance of the user device.

Described herein is a device and method to detect the presence and use of a reference patch with encoded identifier attributes, where the reference patch serves as a conduit for delivering content into the displayed data.

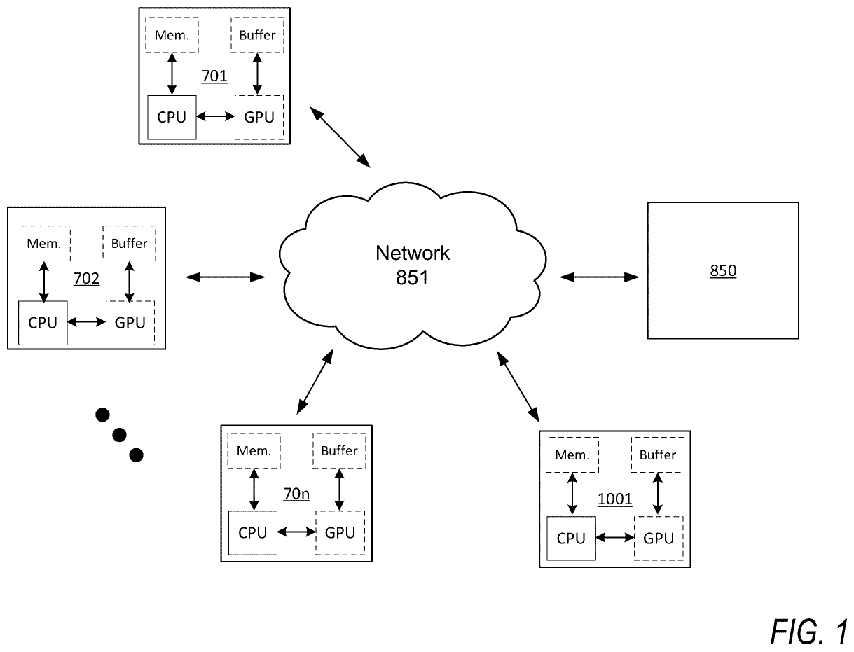

Referring now to the figures, FIG. 1 is a schematic view of an electronic device, such as a client/user device (a first device 701) communicatively connected, via a network 851, to a second electronic device, such as a server (a second device 850), and a generating device 1001, according to an embodiment of the present disclosure. Further, in an embodiment, additional client/user devices can be communicatively connected to both the first device 701 and the second device 850. A second client/user device (a third device 702) can be communicatively connected to the first device 701 and the second device 850. As shown, the client/user devices can be communicatively connected to, for example, an Nth user device 70n.

An application may be installed or accessible on the first device 701 for executing the methods described herein. The application may also be integrated into the operating system of the first device 701. The first device 701 can be any electronic device such as, but not limited to, a personal computer, a tablet pc, a smart-phone, a smart-watch, an integrated AR/VR (Augmented Reality/Virtual Reality) headwear with the necessary computing and computer vision components installed (e.g., a central processing unit (CPU), a graphics processing unit (GPU), integrated graphics on the CPU, etc.), a smart-television, an interactive screen, a smart projector or a projected platform, an IoT (Internet of things) device or the like.

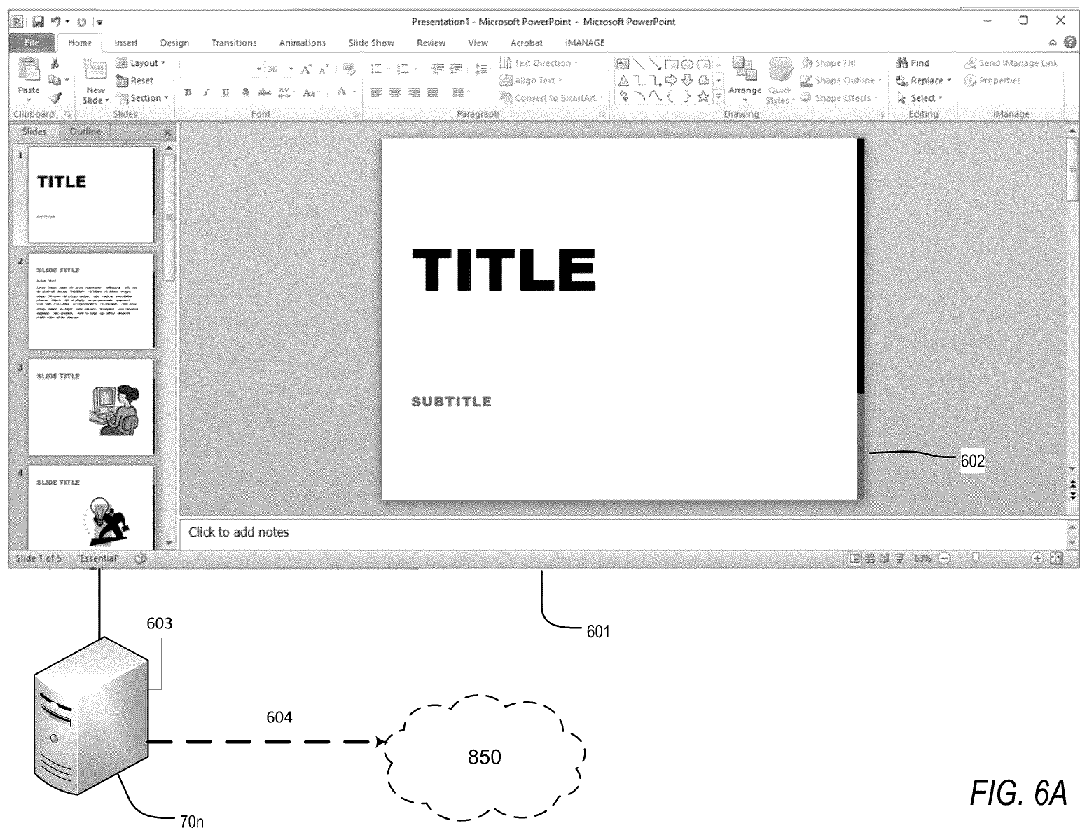

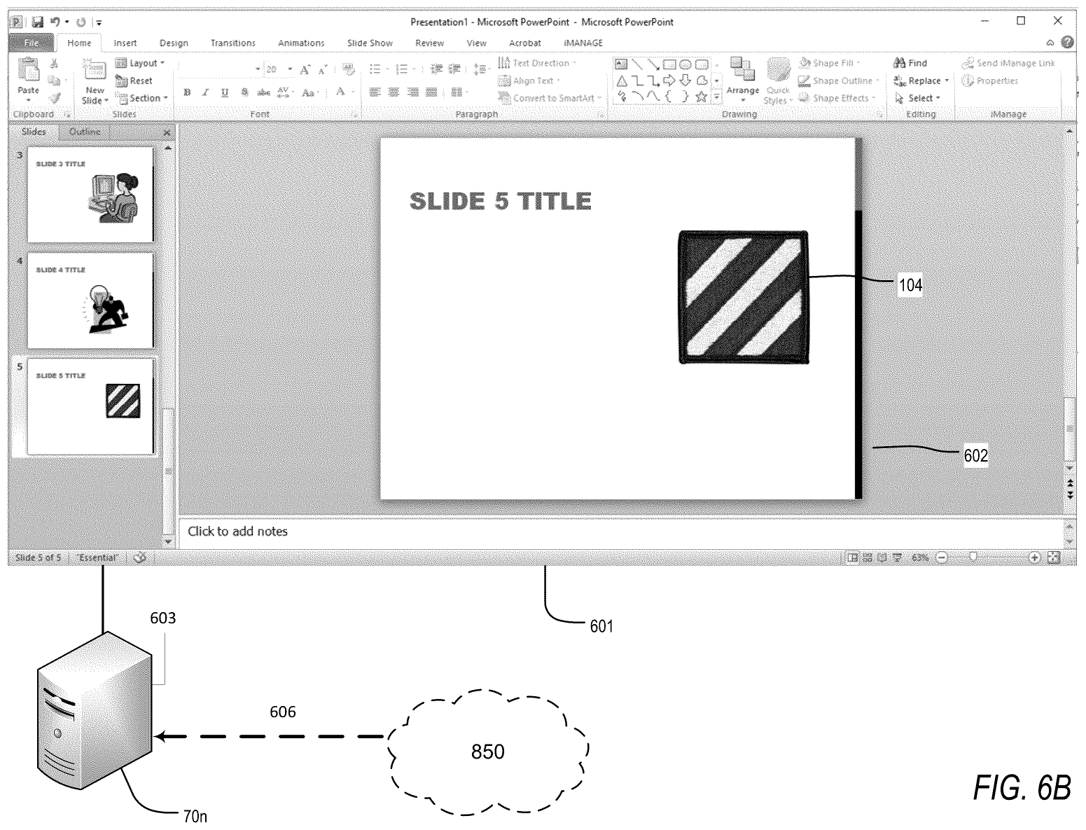

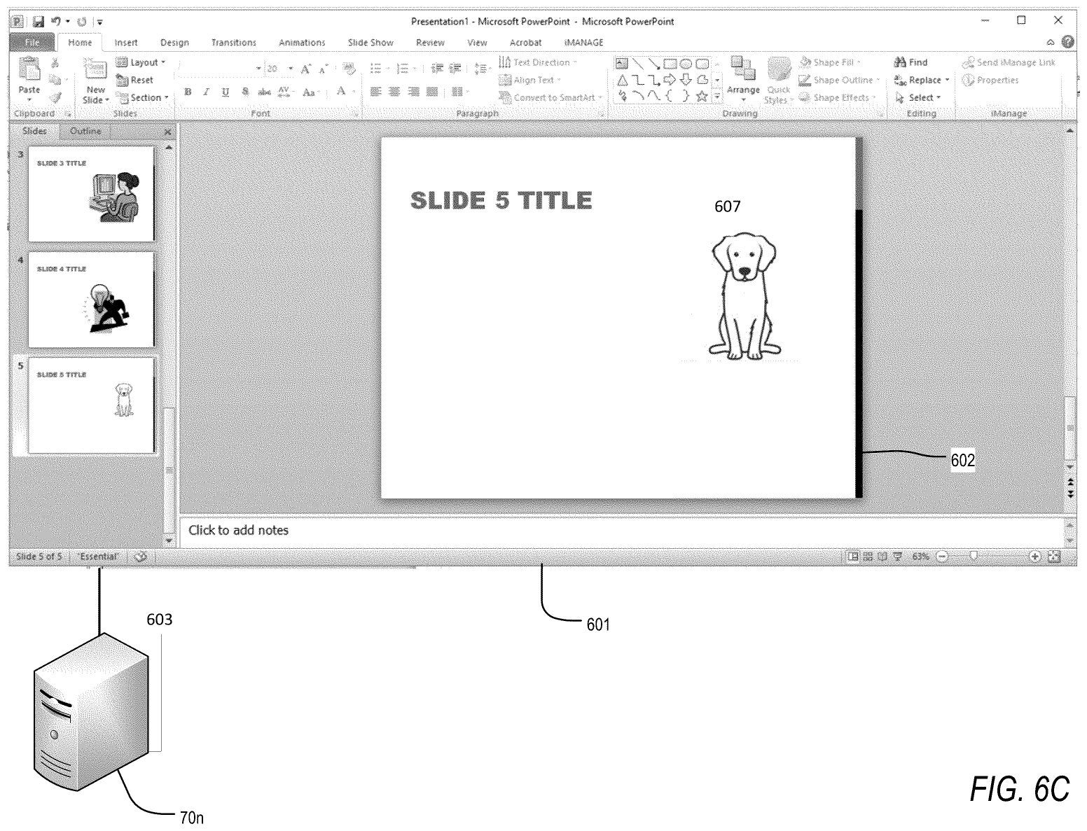

As illustrated in FIG. 1, the first device 701 can include a CPU, a GPU, a frame buffer, and a main memory among other components (discussed in more detail in FIGS. 6-8). In an embodiment, the first device 701 can run software applications or programs that are displayed on a display. In order for the software applications to be executed by the CPU, they can be loaded into the main memory, which can be faster than a secondary storage, such as a hard disk drive or a solid state drive, in terms of access time. The CPU can have an associated CPU memory and the GPU can have an associated video or GPU memory. The main memory can be, for example, random access memory (RAM) and is physical memory that is the primary internal memory for the first device 701. The GPU can display the displayed data pertaining to the software applications. It can be understood that the CPU may have multiple cores or may itself be one of multiple processing cores in the first device 701. The CPU can execute commands in a CPU programming language such as C++. The GPU can execute commands in a GPU programming language such as HLSL. The GPU may also include multiple cores that are specialized for graphic processing tasks. Although the above description was discussed with respect to the first device 701, it is to be understood that the same description applies to the other devices (701, 702, 70n, and 1001) of FIG. 1. Although not illustrated in FIG. 1, the second device 850 can also include a CPU, GPU, and main memory.

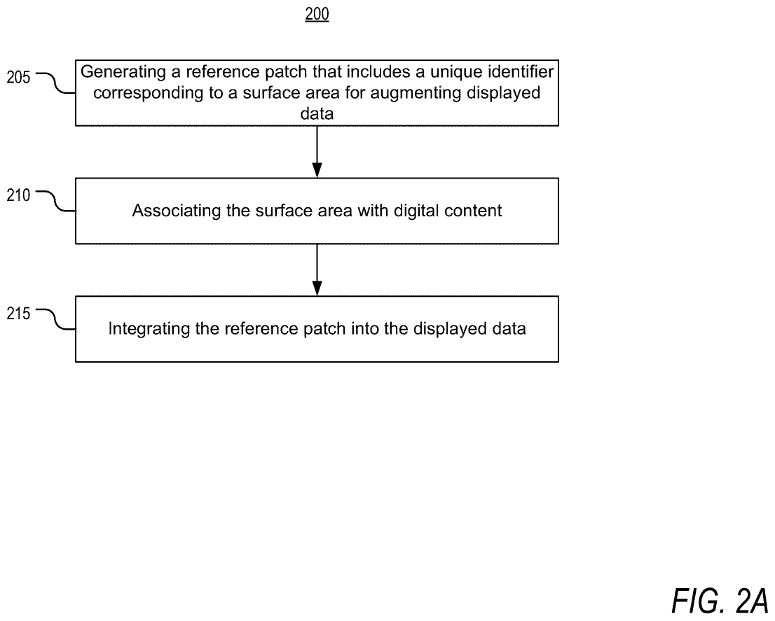

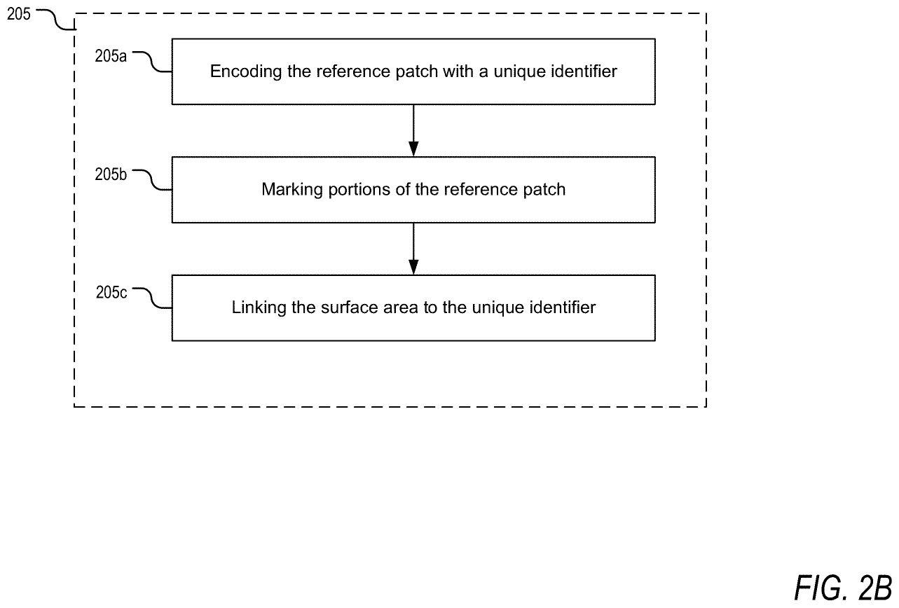

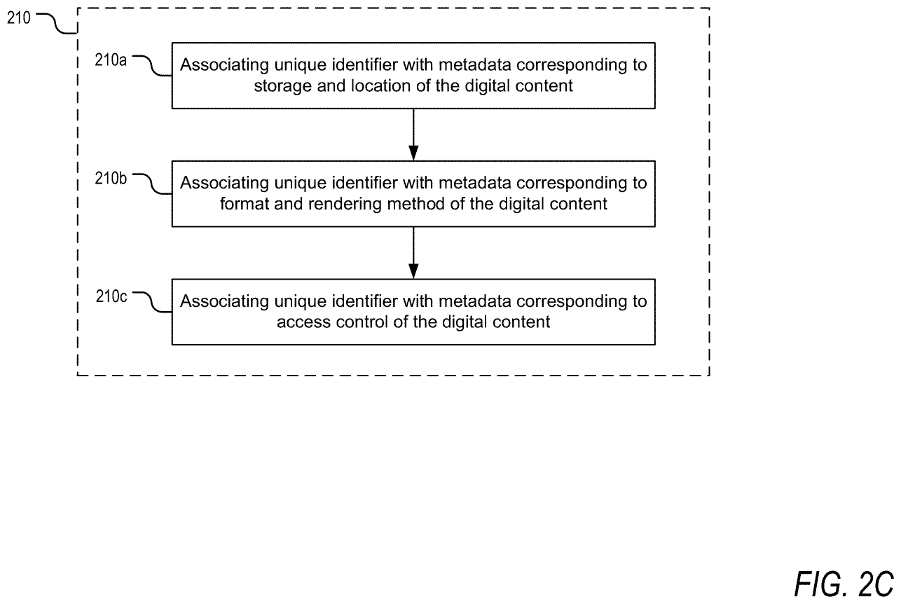

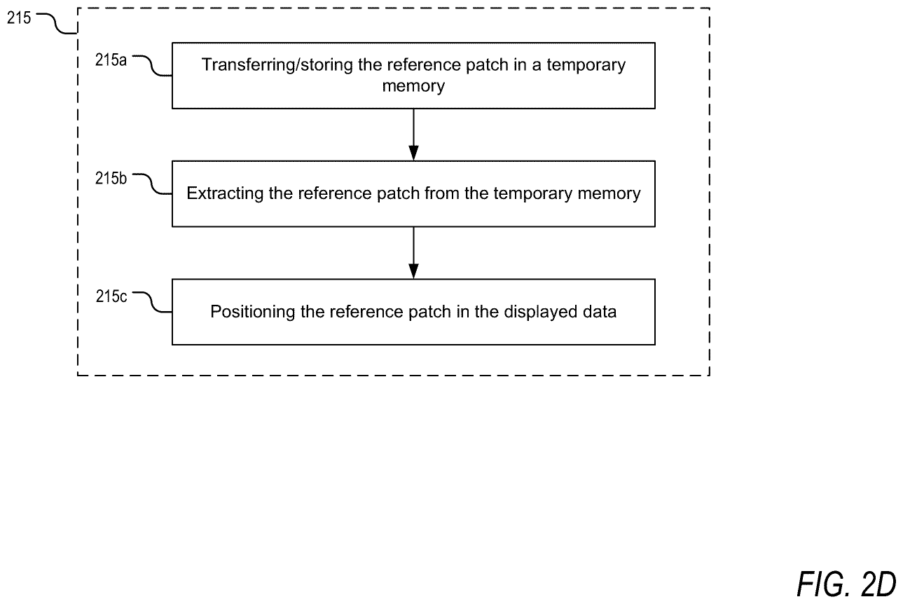

FIG. 2A is a flow chart for a method 200 of generating a reference patch and embedding the reference patch into displayed data, according to an embodiment of the present disclosure. The present disclosure describes generation of the reference patch and embedding of this patch into the displayed data content in order to integrate additional content on the first device 701. In an embodiment, the first device 701 can incorporate content into what is already being displayed (displayed data) for a more immersive experience.

In this regard, the first device 701 can generate the reference patch in step 205. The reference patch can be an object having an area and shape that is embedded in the displayed data at a predetermined location in the displayed data. For example, the reference patch can be a square overlayed and disposed in a corner of a digital document (an example of displayed data), wherein the reference patch can be fixed to a predetermined page for a multi-page (or multi-slide) digital document. The reference patch can thus also represent a region of interest in the digital document. The reference patch can be an object that, when not in a field of view of the user, is inactive. The reference patch can, upon entering the field of view of the user, become active. For example, the reference patch can become active when detected by the first device 701 in the displayed data. When active, the reference patch can retrieve content and augment the displayed data by incorporating the retrieved content into the displayed data. Alternatively, the reference patch can become active when being initially located within the frame of the screen outputting the displayed data. For example, even if another window or popup is placed over top of the reference patch, the reference patch may continue to be active so long as the reference patch remains in the same location after detection and the window including the document incorporating the reference patch is not minimized or closed. As will be described further below, the reference patch can have a predetermined design that can be read by the first device 701, leading to the retrieval and displaying of the content.

In an embodiment, the first device 701 can use a geometrical shape for the reference patch for placement into any displayed data using applications executed in the first device 701. The reference patch can take any shape such as a circle, square, rectangle or any arbitrary shape. In step 210, the reference patch can also have predetermined areas within its shape for including predetermined data. The predetermined data can be, for example, unique identifiers that correspond to a surface area of the displayed data. The unique identifiers can be, for example, a marker. As will be described below, the marker can take the form of patterns, shapes, pixel arrangements, pixel luma, and pixel chroma, among others. The surface area, by way of the unique identifiers, can be associated with predetermined content that is recalled and displayed at the corresponding surface area in the displayed data. The unique identifier can include encoded data (first encoded data) that identifies the content, a location address of the content at the second device 850 (see description below), a screen position within the surface area at which the content is insertable in the displayed data, and a size of the content when inserted in the displayed data (adjustable before being displayed).

That is, in an embodiment, the surface area (or an available area in which content is insertable/to be inserted) of the displayed data can be portion(s) of the displayed data that do not include objects that might obscure the reference patch or the content displayed at the corresponding surface area in the displayed data. For example, the first device 701 can use computer vision (described below) to detect the objects. For example, a slide in a slide deck can include text, pictures, logos, and other media, and the surface area can be the blank space or spaces around the aforementioned objects. Thus, the content can be displayed somewhere in the blank spaces. In an embodiment, the surface area of the displayed data can include portions of the displayed data that already include objects and the content can be displayed at the same location as the objects. For example, a slide in a slide deck can include a picture of a user, and the reference patch can be the area representing a face of the user and the content can be displayed at the same location as a body of the user. For example, a slide in a slide deck can include an image of a vehicle and the reference patch can be disposed in a blank space of the displayed data, while the content retrieved (e.g., a new car paint color and new rims) can be displayed over the image of the vehicle. In other words, the content may be placed in a blank area of the displayed data and/or in an area that is not blank (i.e., an area that includes text, image(s), video(s), etc.).

In step 215, the first device 701 can embed the reference patch into the displayed data, such as a word processing document file (i.e., DOC/DOCX) provided by e.g., Microsoft® Word, in a Portable Document Format (PDF) file such as the ones used by Adobe Acrobat®, in a Microsoft® PowerPoint presentation (PPT/PPTX), or in a video sequence file such as MPEG, MOV, AVI or the like. These file formats are illustrative of some file types which a user may be familiar with; however, applications included in the first device 701 are not limited to these types and other applications and their associated file types are possible.

The reference patch (or similar element) can be embedded into any displayed data, where the displayed data may be generated by an application running on or being executed by the first device 701. The reference patch can encompass the whole area designated by the displayed data, or just a portion of the area designated by the displayed data. The method of generating the reference patch and embedding the reference patch into the displayed data has been described as being performed by the first device 701, however, the second device 850 can instead perform the same functions. In order to be detected in the displayed data on the first device 701, the reference patch may only be simply displayed as an image on the screen. The reference patch may also simply be a raster image or in the background of an image. The reference patch is also able to be read even when the image containing the reference patch is low resolution. Because the reference patch is encoded in a hardy and enduring manner such that even if a portion of the reference patch is corrupted or undecipherable, the reference patch can still be activated and used.

In an embodiment, the reference patch can be embedded inside of a body of an email correspondence. The user can use any electronic mail application such as Microsoft Outlook®, Gmail®, Yahoo®, etcetera. As the application is running on the first device 701, it allows the user to interact with other applications. In an embodiment, the reference patch can be embedded on a video streaming or two-way communication interface such as a Skype® video call or a Zoom® video call, among others. In an embodiment, the reference patch can be embedded in displayed data for multi-party communication on a live streaming interface such as Twitch®.

One way in which the first device 701 may embed the reference patch into the displayed data is by arranging the generated reference patch in the displayed data such as in a desired document or other media. The reference patch may include a facade of the content which becomes an integrated part of the displayed data. The facade can act as a visual preview to inform the user of the content linked to the reference patch. The facade can include, for example, a screenshot of a video to be played, a logo, an animation, or an image thumbnail, among others. The facade can be a design overlay. The design overlay can be a picture that represents the underlying content superimposed over the reference patch. In an embodiment, the facade can indicate the content that is represented by the reference patch. The facade can be contained within the shape of the reference patch or have a dynamic size. For example, attention of the user can be brought to the facade by adjusting the size of the facade when the reference patch is displayed on the display. The adjustment of the size of the facade can also be dynamic, wherein the facade can enlarge and shrink multiple times. By the same token, a position and rotation of the facade can also be adjusted to produce a shaking or spinning effect, for instance.

Unlike traditional means of sending displayed data, the first device 701 may not send the whole content with a header file (metadata) and a payload (data). Instead, the reference patch that may include a facade of the underlying content is placed within the displayed data. If a facade is used, it indicates to the first device 701 that the surface area can have content that can be accessed with selection (clicking with a mouse, touchpad, eye-gaze, eye-blinks, or via voice-command) of the facade. The content can also be accessed or activated automatically, e.g., when the user has the reference patch displayed on the display of the first device 701. Other symbolic means of visualization can be employed to indicate to the user that the surface area is likely to include information for obtaining content. For example, a highlighting effect can be applied along a perimeter of the reference patch in a pulsating pattern of highlighting intensity to bring attention to the presence of the reference patch. For example, a series of spaced dashes surrounding the reference patch and oriented perpendicular to the perimeter of the reference patch can appear and disappear to provide a flashing effect. Other means can be employed to indicate to the user that the surface area is likely to include information for obtaining content, such as an audio cue.

The first device 701 employs further processes before embedding the reference patch into the displayed data. These processes and schemas are further discussed in FIG. 2B.

FIG. 2B is a flow chart of a sub-method of generating the reference patch, according to an embodiment of the present disclosure. The first device 701 can associate the content with the surface area corresponding to the reference patch (e.g., via the unique identifiers included therein) generated by the first device 701. In an embodiment, the surface area may encompass the whole of the displayed data or a portion of it.

The reference patch, which includes the unique identifiers corresponding to the surface area associated with the content, is then embedded into the displayed data by the first device 701. In some use cases, the displayed data including the reference patch can be sent or transmitted to a second user having the third device 702 including the same application, which then allows the second user to access information within the surface area and obtain the content and have it viewable on the third device 702. That is, the third device 702 can have the same displayed data overlaid with the augmenting content on the surface area of the display of the third device 702 in the location or locations defined by the reference patch.

In FIG. 2B, the generating device 1001 uses additional processes to effectuate generation of the reference patch which is obtained and embedded by the first device 701. In an embodiment, the generating device 1001 encodes the reference patch with the unique identifiers corresponding to the surface area in step 205a. The generating device 1001 can mark areas of the reference patch in step 205b to form the marker that, either separately or in combination, define or may be used to access the unique identifiers. The marker can take the form of patterns, shapes, pixel arrangements, or the like. In an example, the marker can have a shape that corresponds to the shape of the surface area. In an example, the marker can have a size that corresponds to the size of the surface area. In an example, the marker can have a perimeter that corresponds to the perimeter of the surface area. The marker can use any feasible schema to provide identifying information that corresponds to the surface area within parts of the displayed data. In an embodiment, the marker can incorporate hidden watermarks that are only detectable by the first device 701 and the third device 702, which have detection functionality implemented therein, for example having the application installed or the functionality built into the operating system.

The marker can incorporate patterns which can then be extracted by the first device 701. In an example, the first device 701 can perform the embedding, then send the content having the embedded reference patch to the third device 702. The encoding is performed by the generating device 1001 and may use any variety of encoding technologies such as the ARUCO algorithm to encode the reference patch by marking the reference patch with the marker. The first device 701 may also be used as the generating device 1001.

In an embodiment, the marker can be comprised of a set of points, equidistant from each other and/or some angle apart from a reference point, such as the center of the reference patch or represent some other fiducial points. That is, the fiducial points corresponding to the marker can provide a set of fixed coordinates or landmarks within the content with which the surface area can be mapped relative to the fiducial points. In an embodiment, the marker can be comprised of a set of unique shapes, wherein predetermined combinations of the unique shapes can correspond to a target surface area (or available area, or areas) for displaying the displayed data. The predetermined combinations of the unique shapes can also correspond to predetermined content for displaying in the surface area. The predetermined combinations of the unique shapes can also correspond to/indicate a position/location where the content should be displayed at the surface area relative to a portion of the surface area. A combination of the set of points and unique identifiers can be used as well. In one embodiment, pixel coordinates of the reference patch can be determined, and the objects can be displayed relative to the pixel coordinates of the reference patch.

For example, the unique identifiers can be unique shapes that correlate to predetermined content as well as indicating where the content should be overlayed on the display (the screen position) relative to a set of points marked on the reference patch. The unique identifiers can also indicate a size of the content to be overlayed on the display, which can be adjustable based on the size of the surface area (also adjustable) and/or the size of the display of the first device 701. The unique identifiers can be relatively invisible or undetectable to the user, but readable by the first device 701 and cover predetermined areas of the reference patch. The unique identifiers, and by extension, the marker, can have an appearance that is marginally different from an appearance of the area of the reference patch. For example, the area of the reference patch can appear white to the user and the unique identifiers can also appear white to the user but may actually have a slightly darker pixel color that can be detected and interpreted by a device, such as the first device 701. For instance, the appearance of the unique identifiers can be 0.75% darker than the white color of the area of the reference patch. Such a small difference can be identified and discerned by the first device 701 while being substantially imperceptible to the user.

In an embodiment, the area of the reference patch can be divided into sections, for instance a set of squares, wherein a marker is included within each square. An example of a marker includes a letter. For example, a reference patch is divided into 16 squares, wherein each square is designated to represent different information, e.g., a timestamp, a domain, a version. Thus, the marker in each square is interpreted according to the designation of that square. An identification based on the set of squares can be, for example, an 18-character (or “letter”) hexadecimal. The set of squares can further include additional subsets for a randomization factor, which can be used for calculating a sha256 hash prior to encoding the reference patch with the hash. Together, the set of squares having the marker included therein can comprise the unique identifiers.

Moreover, the generating device 1001 can also employ chroma subsampling to mark attributes represented by a particular pattern. In an embodiment, the generating device 1001 can mark parts of the reference patch with predetermined patterns of pixel luma and chroma manipulation that represent a shape, a size, or a position of the surface area for displaying the content. Moreover, the generating device 1001 can mark a perimeter of the reference patch with a predetermined edging pattern of pixel luma and chroma manipulation that represents a perimeter of the surface area for displaying the content.

The generating device 1001 can further link the surface area with unique identifiers in step 205c. The unique identifiers can be hashed values (such as those described above) that are generated by the generating device 1001 when the reference patch is generated (such as the one having the area of the reference patch divided into the subset of squares).

FIG. 2C is a flow chart of a sub-method of associating the surface area with content, according to an embodiment of the present disclosure. In FIG. 2C, the generating device 1001 uses additional processes to associate the surface area with content. In an embodiment, the generating device 1001 can associate the unique identifiers corresponding to the surface area with metadata. In step 210a, the unique identifiers can be associated with metadata embodying information about the storage and location of the content. Moreover, in step 210b, the generating device 1001 can associate the unique identifier of the surface area with metadata which embodies information about the format and rendering information used for the content. In step 210c, the generating device 1001 can associate the unique identifiers of the surface area with metadata which embodies access control information of the content.

In an embodiment, the storage of the content can be on a remote server, such as the second device 850, and the location of the content can be the location address of the memory upon which it is stored at the remote server. The storage and location of the content are thus linked with the metadata that can point to where the content can later be obtained from. The content is not embedded into the displayed data. In an embodiment, the format and rendering information about the content is embodied in the metadata and associated with the unique identifiers. This information is helpful when the first device 701 or the third device 702 are on the receiving end of the transmitted displayed data and need to properly retrieve and process the content.

Moreover, in an embodiment, the access control of the content can also be encompassed in the metadata and associated with the unique identifiers corresponding to the surface area. The access control can be information defining whether the content can be accessed by certain individuals or within a certain geographical location. The access control information can define restrictions such as those placed upon time and date as to when and how long the content can be accessed. The access control information can define the type of display reserved for access by the first device 701. For example, a user may wish to restrict access to the content to certain types of devices, such as smartphone or tablets. Thus, the metadata defining a display requirement would encompass such an access control parameter. In one embodiment, the access control further includes how long a device can access the content, sharing settings, and/or password protection of the content.

FIG. 2D is a flow chart of a sub-method of integrating the reference patch into the displayed data, according to an embodiment of the present disclosure. In FIG. 2D, the generating device 1001 uses additional processes to effectuate integration of the reference patch into the displayed data. In an embodiment, the first device 701 can temporarily transfer or store the reference patch in a storage of the first device 701 in step 215a. The storage can be accessed by the first device 701 for embedding the reference patch into the displayed data at any time. The first device 701 can extract the reference patch from the storage for embedding purposes in step 215b. The first device 701 can also arrange the reference patch at a predetermined location and with a predetermined reference patch size in step 215c. The first device 701 can further embed the reference patch such that a document, for example, having the reference patch embedded therein can be sent to a recipient, for example the second user using the third device 702, where he/she can access the document using the application on the third device 702 as further described below. Again, the features of the generating device 1001 can be performed by the first device 701.

The displayed data can be output from a streaming application or a communication application with a data stream having the reference patch embedded therein. The actual content may not be sent along with the underlying displayed data or data stream, but only the unique identifier and/or a facade of the content is sent. The unique identifier and/or the underlying metadata can be stored in a cloud-based database such as MySQL which can point to the second device 850 or a cloud-based file hosting platform that ultimately houses the content. No limitation is to be taken with the order of the operation discussed herein; such that the sub-methods performed by the first device 701 can be carried out synchronous to one another, asynchronous, dependently or independently of one another, or in any combination. These stages can also be carried out in serial or in parallel fashion.

There can be many ways to identify a reference patch within a frame of displayed data. In one embodiment, the displayed data can be stored in a frame buffer. A frame buffer is a segment of memory that stores pixel data as a bitmap, or an array of bits. Each pixel in the display is defined by a color value. The color value is stored in bits. In one embodiment, the frame buffer can include a color lookup table, wherein each pixel color value is an index that references a color on the lookup table. A frame buffer can store a single frame of displayed data or multiple frames of displayed data. In order to store multiple frames of displayed data, the frame buffer includes a first buffer and at least one additional buffer. A currently displayed frame of displayed data is stored in the first buffer, while at least one subsequent frame is stored in the at least one additional buffer. When the subsequent frame is displayed, the first buffer is then filled with new displayed data. Frame buffers can be stored in a graphics processing unit (GPU). In one embodiment, each of the second electronic devices (e.g., the first device 701, the second client/user device 702, the nth user device 70n) can access the frame buffer in the GPU and analyze the pixel data in order to identify a reference patch.

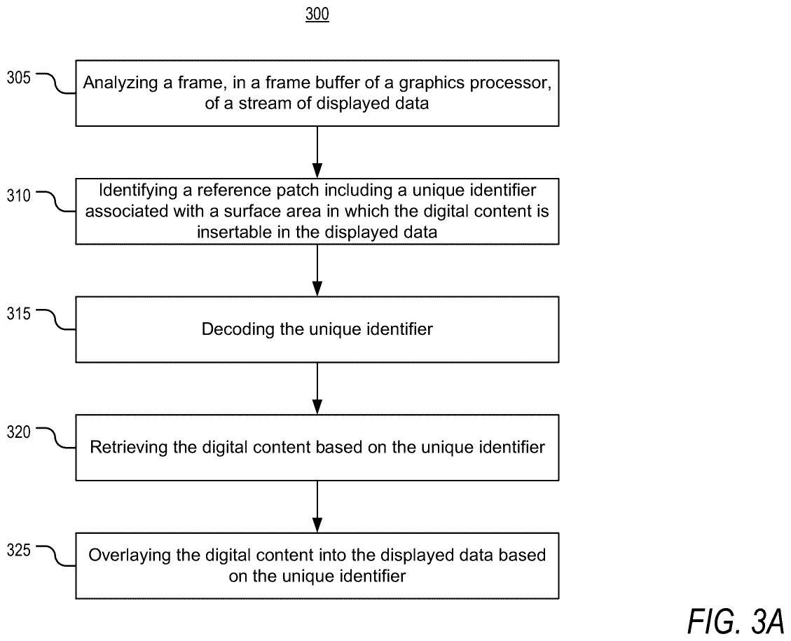

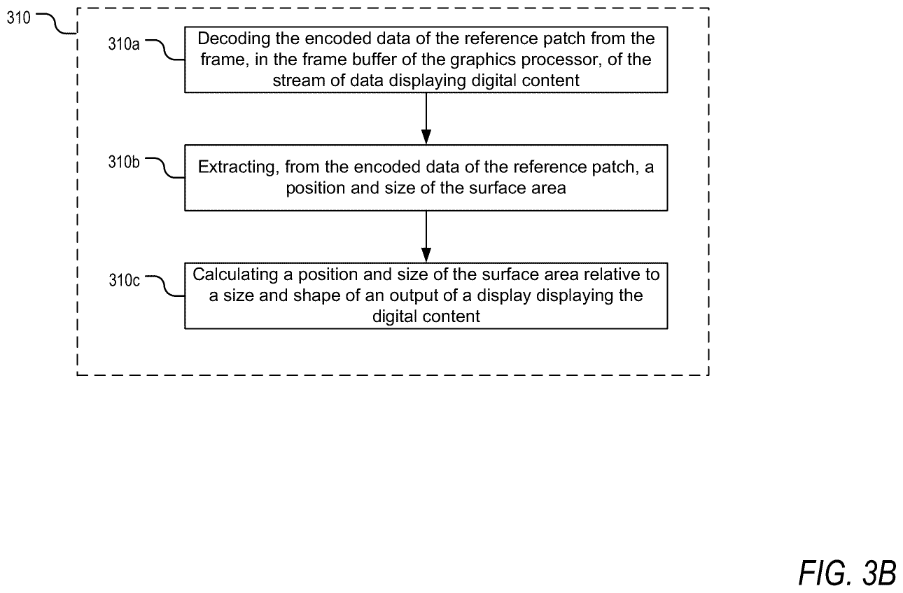

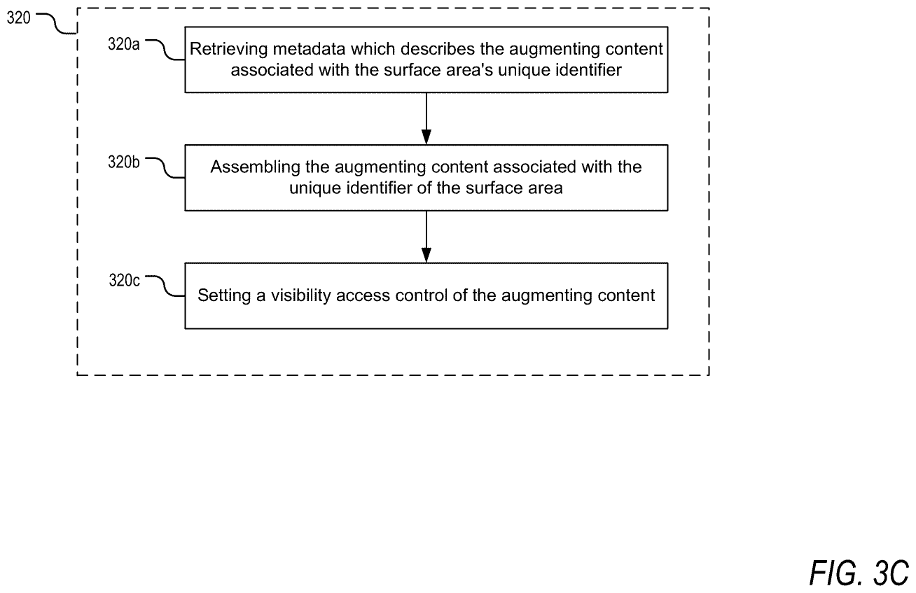

FIG. 3A is a flow chart for a method 300 of identifying the reference patch included in the displayed data and overlaying the content into displayed data, according to an embodiment of the present disclosure. In an embodiment, in step 305, the first device 701 can inspect the stream of data being outputted by the first device's 701 video or graphics card and onto the display of the first device 701. That is, the first device 701 can access a frame buffer of the GPU and analyze, frame by frame, in the frame buffer, the outputted stream of data which can include the displayed data. In an embodiment, a frame represents a section of the stream of the displayed data that is being displayed by the first device 701. In that regard, the first device 701 can inspect the outputted stream of data. The first device 701 can achieve this by intercepting and capturing data produced from the first device 701's video card or GPU that is communicated to the first device 701's display. Inspecting the frame buffer is a method for visually identifying the reference patch as part of the display content.

In an embodiment, in step 310, the first device 701 can process attributes of each pixel included in a single frame and detect groups of pixels within that frame, which may have a known predetermined pattern of pixel luma and chroma manipulation, in order to find the reference patch.

In one embodiment, the first device 701 can identify the reference patch based on a confidence level for a predetermined pattern of pixel luma and chroma manipulation and/or a predetermined edge pattern of pixel luma and chroma manipulation. For example, the first device 701 can identify a reference patch wherein the reference patch is a uniform gray rectangle surrounded by a white background. The pattern of chroma manipulation of gray rectangle in contrast with the surrounding pixel data is identifiable as a reference patch. In another embodiment, the first device 701 can identify a line segment separating a reference patch from the remainder of the displayed data based on the color and/or brightness of the line segment. In one embodiment, the first device 701 can inspect pixels in batches. In one embodiment, identifying the reference patch is done by inspecting the frame buffer using computer vision, including, but not limited to, image recognition, semantic segmentation, edge detection, pattern detection, object detection, image classification, and/or feature recognition. Examples of artificial intelligence computing systems and techniques used for computer vision include, but are not limited to, artificial neural networks (ANNs), generative adversarial networks (GANs), convolutional neural networks (CNNs), thresholding, and support vector machines (SVMs). Computer vision is useful when the displayed data includes complex imagery and/or when the reference patch would otherwise blend into the displayed data. For example, an image of a car is a reference patch, and the displayed data includes multiple images of cars. Computer vision enables the first device 701 to accurately identify the specific image of the car that is the reference patch in the displayed data.

In a non-limiting example, the processor-based computer vision operation can include sequences of filtering operations, with each sequential filtering stage acting upon the output of the previous filtering stage. For instance, when the processor is a graphics processing unit (GPU), these filtering operations are carried out by fragment programs. In the event an input to the operation is an image, the input images are initialized as textures and then mapped onto quadrilaterals. Displaying the input in quadrilaterals ensures a one-to-one correspondence of image pixels to output fragments. Similarly, when the input to the operation is an encoded image, a decoding process may be integrated into the processing steps described above. A complete computer vision algorithm can be created by implementing sequences of these filtering operations. After the texture has been filtered by the fragment program, the resulting image is placed into texture memory, either by using render-to-texture extensions or by copying the frame buffer into texture memory. In this way, the output image becomes the input texture to the next fragment program. This creates a pipeline that runs the entire computer vision algorithm. However, often a complete computer vision algorithm will require operations beyond filtering. For example, summations are common operations. Furthermore, more-generalized calculations, such as feature tracking, can also be mapped effectively onto graphics hardware.

In an embodiment, the reference patch can be identified by use of edge detection methods. In particular, edge detection can be used for the perimeter of the reference patch having a predetermined pattern (the predetermined edging pattern). In an example, the edge detection method may be a Canny edge detector. The Canny edge detector may run on the GPU. In one instance, the Canny edge detector can be implemented as a series of fragment programs, each performing a step of the algorithm.

In an embodiment, the identified reference patch can be tracked from frame to frame using feature vectors. Calculating feature vectors at detected feature points is an operation in computer vision. A feature in an image is a local area around a point with some higher-than-average amount of uniqueness. This makes the point easier to recognize in subsequent frames of video. The uniqueness of the point is characterized by computing a feature vector for each feature point. Feature vectors can be used to recognize the same point in different images and can be extended to more generalized object recognition techniques.

Feature detection can be achieved using methods similar to the Canny edge detector that instead search for corners rather than lines. If the feature points are being detected using sequences of filtering, the GPU can perform the filtering and read back to the CPU a buffer that flags which pixels are feature points. The CPU can then quickly scan the buffer to locate each of the feature points, creating a list of image locations at which feature vectors on the GPU will be calculated.

In step 315, the first device 701 can decode the encoded data of the unique identifier included with the reference patch wherein the unique identifier corresponds to a surface area for augmentation. In one embodiment, a reference patch can include unique identifiers. In one embodiment, the unique identifier is a hashed value. In one embodiment, the unique identifier was generated by the first device 701. In one embodiment, the unique identifier was generated by an external device, e.g., the second device 850, the second client/user device 702, the nth user device 70n.

In step 320, the first device 701 can use the unique identifier to retrieve content. In one embodiment, the unique identifier describes the content, the location address, metadata, or other identifying information about the content. In one embodiment, the first device 701 retrieves the content from a server, e.g., the networked device 750. In one embodiment, the first device 701 retrieves the content from main memory.

In step 325, the first device 701 can overlay the content onto the surface area of the displayed data. In one embodiment, the location of the content is the surface area described by the unique identifier. The content is overlaid as an additional layer to the displayed data. Although the content is visually merged with the displayed data, the data itself is isolated from the displayed data and can be modified independently of the rest of the displayed data.

Again, the method of identifying the reference patch included in the displayed data and augmenting the displayed data is described as performed by the first device 701, however, the second device 850 can instead perform the same functions.

In an embodiment, the first device 701 identifies the surface area corresponding to the reference patch by employing further processes to process the frames. To this end, FIG. 3B is a flow chart of a sub-method of identifying the reference patch with the unique identifiers corresponding to the surface area from the stream of data, according to an embodiment of the present disclosure.

In step 310a, the first device 701 can decode the encoded reference patch from the frame. The encoded reference patch can include the marker that makes up the unique identifiers within the reference patch incorporated previously. The reference patch can also include other identifying information. The marker can be disposed within the reference patch, such as within the area of the reference patch or along a perimeter of the reference patch, or alternatively, outside of the area of the reference patch.

Whatever schema is used to encode the marker in the reference patch is also used in reverse operation to decode the underlying information contained within the reference patch. As stated above, in an embodiment, the encoded marker can be patterns generated and decoded using the ARUCO algorithm or by other algorithms that encode data according to a predetermined approach.

In step 310b, the first device 701 can also extract attributes of the surface area from the reference patch. In an embodiment, the position, size, shape, and perimeter of the surface area are extracted, although other parameters can be extracted as well. Other parameters include boundary lines, area, angle, depth of field, distance, ratio of pairs of points, or the like. In an embodiment, where shape and perimeter are designated as the attributes, the first device 701 makes determinations of size, shape, and perimeter and outputs that result. Specifically, the size or shape of the surface area can be determined by evaluating a predetermined or repeatable pattern of pixel luma and chroma manipulation in the reference patch. The predetermined pattern can be marked on, within the area, or outside of the area of the reference patch. The predetermined pattern can correspond to the size or shape of the surface area. The predetermined pattern can correspond to the size or shape of the content. The perimeter of the surface area can also be determined by evaluating a predetermined edging pattern of pixel luma and chroma manipulation. The predetermined edging pattern can be marked on, within the area, or outside of the area of the reference patch. That is, the predetermined edging pattern of the reference patch can correspond to the perimeter of the surface area. The predetermined edging pattern of the reference patch can correspond to the perimeter of the content.

In step 310c, the first device 701 can also calculate a position and size of the surface area relative to the size and shape (dimensions) of the output signal from the display that is displaying the displayed data. In an embodiment, the calculating of the size, relative to the size and shape of the outputted signal from the display, includes determining the size of the surface area by inspecting a furthest measured distance between the edges of the surface area. Furthermore, the calculating of a location of the surface area, relative to the size and shape of the outputted signal from the display, includes determining the location of the surface area relative to the size and shape of the displayed data outputted through the display. This includes calculating the distance between the outer edges of the surface area and the inner edges of the displayed data being outputted by the display. The determined size and location of the surface area can be outputted as a result. Notably, prior to overlaying the content into the displayed data, the first device 701 can adjust, based on the predetermined pattern and the predetermined edging pattern, the size and perimeter of the content for displaying in the display of the first device 701. For example, the size and perimeter of the content for displaying in the display of the first device 701 can be scaled based on the size and perimeter of the surface area and/or the size of the display.

The first device 701 can provide information regarding the characteristics of the output video signal, such that the content that is later overlaid can correctly be displayed to account for various manipulations or transformations that may take place due to hardware constraints, user interaction, image degradation, or application intervention. Such manipulations and transformations may be the relocation, resizing, and scaling of the reference patch and/or the surface area, although the manipulations and transformations are not limited to those enumerated herein.

In an embodiment, the reference patch itself can be used as the reference for which the content is displayed on the surface area. In one example, the location at which to display the content in the surface area can be determined relative to the location of the reference patch on the displayed data. In one example, the size of the surface area can be determined relative to the size of the reference patch on the displayed data. In an example employing a combination of the two properties of the reference patch, the reference patch displayed in the displayed data on a smart phone having a predetermined size and a surface area can be scaled relative to the predetermined size of the display of the smart phone. This can be further adjusted when the reference patch in the same displayed data is displayed on a desktop monitor, such that the predetermined size of the reference patch in the displayed data displayed on the desktop monitor is larger and thus the size of the surface area can be scaled to be larger as well. Furthermore, the location of the surface area can be determined via a function of the predetermined size of the reference patch. For example, the location at which to display the content in the surface area can be disposed some multiple widths laterally away from the location of the reference patch as well as some multiple heights longitudinally away from the location of the reference patch. As such, the predetermined size of the reference patch can be a function of the size of the display of the first device 701. For example, the predetermined size of the reference patch can be a percentage of the width and height of the display, and thus the location and the size of the surface area are also a function of the width and height of the display of the first device 701.

In an embodiment, the first device 701 can determine an alternative location at which to display the content based on behaviors of the user. For example, the first device 701 can compare the encoded data corresponding to the location at which to display the content in the surface area to training data describing movement and focus of the user's eyes while viewing the displayed data. Upon determining the location at which to display the content in the surface area (as encoded in the reference patch) is not the same as the training data, the first device 701 can instead display the content at the location described by the training data as being where the user's eyes are focused in the displayed data at a particular time. For example, the user's eyes may be predisposed to viewing a bottom-right of a slide in a slide deck. The first device 701 can decode the reference patch and determine the content is to be displayed in a bottom-left of the slide deck. The training data can indicate that, for example, the user's eyes only focus on the bottom-left of the slide 10% of the time, while user's eyes focus on the bottom-right of the slide 75% of the time. Thus, the first device 701 can then display the content in the bottom-right of the slide instead of the bottom-left. The training data can also be based on more than one user, such as a test population viewing a draft of the slide deck. For example, the training data can be based on multiple presentations of the slide deck given to multiple audiences, wherein eye tracking software determines the average location of the audience's focus on each of the slides.

In an embodiment, the first device 701 employs other processes to associate the unique identifiers with the content. To this end, FIG. 3C is a flow chart of a sub-method of associating the unique identifiers with content, according to an embodiment of the present disclosure. In step 320a, the first device 701 can send the unique identifiers to the second device 850 and the second device 850 can retrieve metadata that describes the content, the content being associated with the surface area through the unique identifiers. This can be done by querying a remote location, such as a database or a repository, using the unique identifiers of the surface area as the query key. In an embodiment, the first device 701 sends the unique identifiers to the second device 850 and the second device 850 associates the unique identifier of the reference patch to corresponding content based on the metadata. The metadata associated with the surface area's unique identifier can be transmitted to the first device 701 with the augmentation content.

In step 320b, the first device 701 can assemble the content that is associated with the surface area's unique identifier. The assembly can entail loading the necessary assets for assembling the content. In an embodiment, this can entail loading manipulation software or drivers in order to enable the first device 701 to process the content. Other assembling processes can be the loading of rendering information in order to transform and manipulate an individual portion of the content. Furthermore, the loaded manipulation software, drivers, or rendering information can be used to compile all the individual portions of the entire content together. In an embodiment, this can include adapting the file formats of the content, delaying the playback for the content, converting from one format to another, scaling the resolution up or down, converting the color space, etc.

In step 320c, the first device 701 can provide access control parameters for the content. The access control parameters can dictate whether the content is visible to some users, or to some geographical locations, or to some types of displays and not others, as well as the date and time or duration of time a user can access the content or is allowed to access. In an embodiment, visibility of the content can be defined for an individual. For example, the content can be a video that is appropriate for users over a certain age. In an embodiment, visibility of the content can be defined for a geographic location. For example, the content can be a video that is region-locked based on a location of the first device 701. In an embodiment, visibility of the content can be defined for a type of display displaying the displayed data. For example, the content can be VR-based and will only display with a VR headset. In an embodiment, visibility of the content can be defined for a predetermined date and a predetermined time. For example, the content can be a video that will only be made publicly available after a predetermined date and a predetermined time. In an embodiment, visibility of the content can be defined for a time period. For example, the content can be a video that is only available for viewing during a holiday. The first device 701 thus calculates the user's access level based on those parameters and provides an output result as to the user's ability to access the content, i.e., whether the content will be visible or invisible to the user. Note that the access control parameters can be global, for all the displayed data, or it can be localized per surface area and the underlying content.

Referring again to FIG. 3A, in step 325, the first device 701 can carry on the processes of overlaying the surface area with the content into the displayed data in accordance with certain parameters, such as the surface area, the position, and the size identified by the unique identifier. The first device 701 can determine or adjust the size and location of the assembled content on the surface area relative to the size and shape of the displayed data being outputted by the display. Then, the first device 701 can render the associated content (or the assembled individual portions) over the surface area's shape and perimeter using the size and location information. Thus, the content is superimposed on top of the surface area.

This methodology can be referred to as “computer vision”.

The first device 701 can continuously monitor changes that are taking place at the end user's device (such as the second device 702 of the second user) to determine whether the reference patch and/or the surface area has moved or been transformed in any way. Thus, the first device 701 can continuously inspect subsequent frames of the stream of the data (for example, every 1 ms or by reviewing every new frame), displaying the displayed data, to determine these changes. The first device 701 can further continuously decode the reference patch's data from the identified reference patch. Then the first device 701 can continuously extract attributes from the data, the attributes being of size, shape, and perimeter and comparing those changes between the current frame and last frame. Further, the first device 701 can continuously calculate the size and location of the surface area and compare changes between the size and location of the surface area from the current and the last frame and then continuously overlay the content on the surface area by incorporating the changes in the reference patch's attributes and the changes in the size and location of the surface area. As stated above, when the user manipulates his/her display device by scaling, rotating, resizing or even shifting the views from one display device and onto another display device, the first device 701 can track these changes and ensure that the content is properly being superimposed onto the surface area.

In one embodiment, a device (e.g., the first device 701) can inspect the memory of the device in order to identify the reference patch. A frame buffer stores a limited number of frames of displayed data. Displayed data can also be stored in the main memory of a device, wherein the main memory refers to internal memory of the device. The operating system (OS) and software applications can also be stored in the main memory of a device.

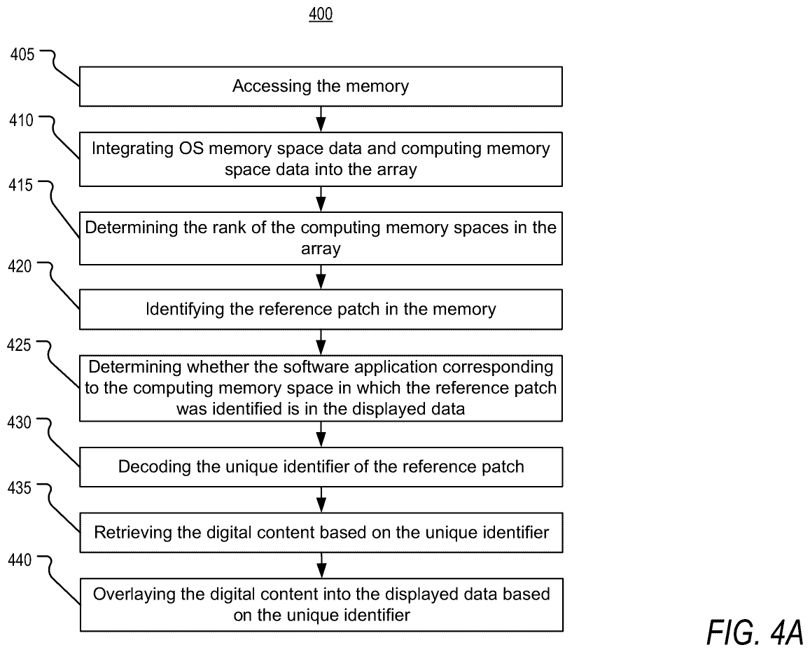

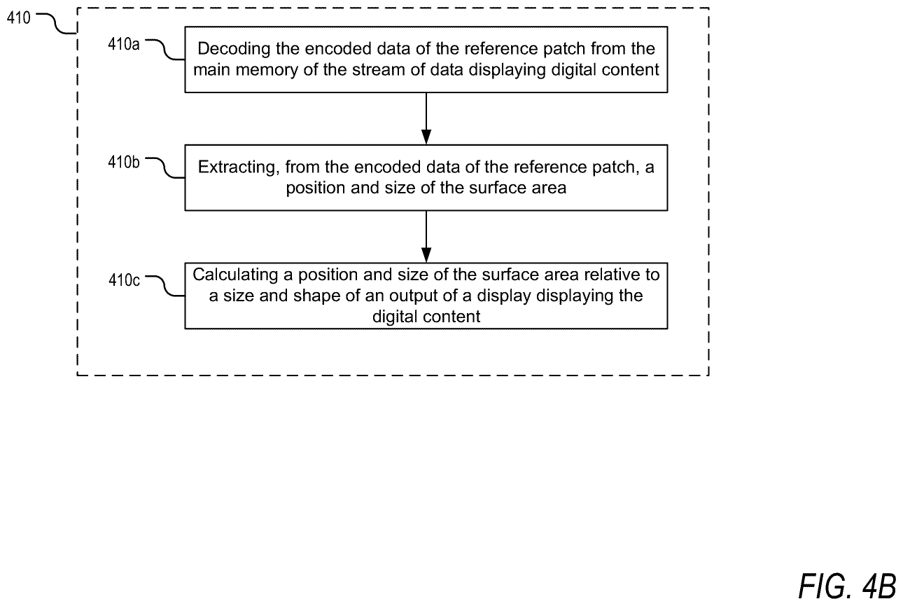

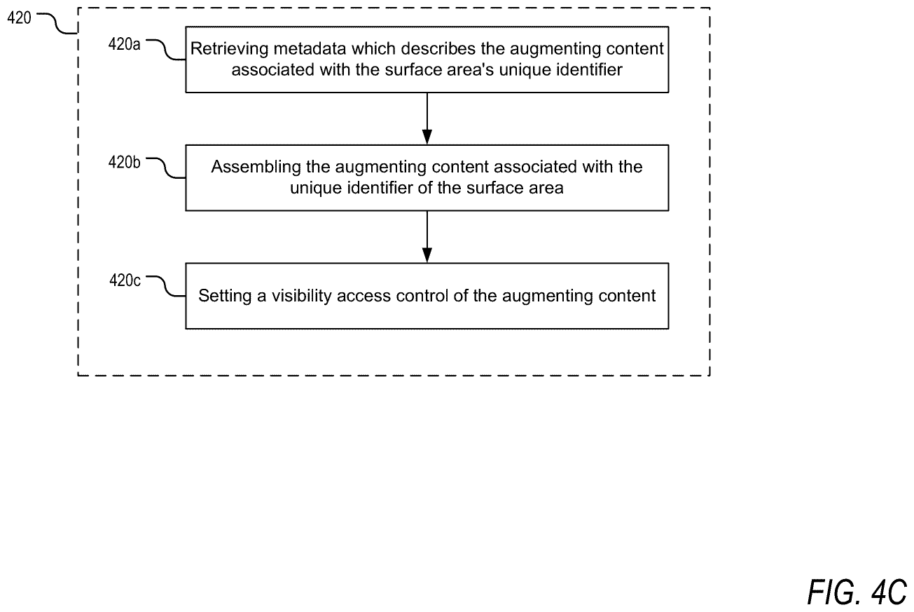

FIG. 4A is a flow chart for a method 400 of identifying the reference patch included in the displayed data and overlaying the content into displayed data, according to an embodiment of the present disclosure. In an embodiment, in step 405, the first device 701 can inspect the main memory on the first device 701. Again, the main memory of the first device 701 refers to physical internal memory of the first device 701 where all the software applications are loaded for execution. Sometimes complete software applications can be loaded into the main memory, while other times a certain portion or routine of the software application can be loaded into the main memory only when it is called by the software application. The first device 701 can access the main memory of the first device 701 including an operating system (OS) memory space, a computing memory space, and an application sub-memory space for the computing memory space in order to determine, for example, which software applications are running (computing memory space), how many windows are open for each software application (application sub-memory space), and which windows are visible and where they are located (or their movement) on the display of the first device 701 (OS memory space). That is to say, the OS memory takes up a space in (or portion of) the main memory, the computing memory takes up a space in (or portion of) the main memory, and the application sub-memory takes up a space in (or portion of) the computer memory. This information can be stored, for example, in the respective memory spaces. Other information related to each software application can be obtained and stored and is not limited to the aforementioned features.

In an embodiment, in step 410, the first device 701 can aggregate the various memory spaces into an array (or table or handle). That is, the first device 701 can integrate data corresponding to the OS memory space and data corresponding to the computing memory space into the array. The array can be stored on the main memory of the first device 701 and include information regarding the software applications running on the first device 701. In an embodiment, the computing memory spaces (including the application sub-memory spaces) can be aggregated into the array. This can be achieved by querying the main memory for a list of computing memory spaces of all corresponding software applications governed by the OS and aggregating all the computing memory spaces obtained from the query into the array. This can be, for example, aggregating the computing memory space of a PowerPoint file and the computing memory space of a Word file into the array. The information in the computing memory spaces stored in the array can include metadata of the corresponding software application. For example, for PowerPoint, the information in the array can include a number of slides in a presentation, notes for each slide, etc. Moreover, each window within the PowerPoint file and/or the Word file can be allocated to a sub-memory space. For example, the array can include the location of each window for each software application running on the first device 701, which can be expressed as an x- and y-value pixel coordinate of a center of the window. For example, the array can include the size of each window for each software application running on the first device 701, which can be expressed as a height and a width value.

In an embodiment, in step 415, the first device 701 can determine a rank or a hierarchy of the computing memory spaces in the array. The rank can describe whether a window of a software application or the software application itself is active or more active as compared to another software application running on the first device 701. An active window or software application can correspond to the window or software application that is currently selected or clicked in or maximized. For example, an active window can be a window of a web browser that the user is scrolling through. In an embodiment, this can be achieved by querying the OS memory space and each computing memory space in the main memory for existing sub-memory spaces, querying the OS memory space and each computing memory space in the main memory for a rank or hierarchical relationship between (software application) sub-memory spaces found, recording the list of sub-memory spaces and the rank relationship between sub-memory spaces, and associating the list of sub-memory spaces and the rank relationship between the sub-memory spaces with the array. For example, a window of a first application can be an active window on the first device 701 and has a higher rank than an inactive window of a second application also running on the first device 701. The active window can be the window the user has currently selected and displayed over all other windows on the display of the first device 701. Notably, there can be multiple visible windows, but one of said multiple visible windows can have a higher rank because it is currently selected by the user and the active window.

For example, two documents can be viewed in a split-screen side-by-side arrangement without any overlap of one window over another window, and a third document can be covered by the two documents in the split-screen side-by-side arrangement. In such an example, the user can have one of the two split-screen documents selected, wherein the selected document is the active window and would have a higher rank (the highest rank) than the other of the two split-screen documents since the higher (highest) ranked document is selected by the user. The third document behind the two split-screen documents would have a lower rank (the lowest rank) than both of the two split-screen documents since it is not visible to the user. Upon bringing the third document to the front of the display and on top of the two split-screen documents, the third document rank would then become the highest rank, while the two split screen documents' rank would become lower (the lowest) than the third document (and the rank of the two split screen documents can be equal).

In an embodiment, the rank can be determined based on eye or gaze tracking of the user (consistent with or independent of whether a window is selected or has an active cursor). For example, a first window and a second window can be visible on the display, wherein the first window can include a video streaming from a streaming service and the second window can be a word processing document. The rank of the first window and the second window can be based on, for example, a gaze time that tracks how long the user's eyes have looked at one of the two windows over a predetermined time frame. The user may have the word processing document selected and active while the user scrolls through the document, but the user may actually be watching the video instead. In such a scenario, an accrued gaze time of the first window having the video can be, for example, 13 seconds out of a 15 second predetermined time frame, with the other 2 seconds in the predetermined time frame being attributed to looking at the first window having the word processing document. Thus, the rank of the first window having the video can be higher than the rank of the second window because the gaze time of the first window is higher than the gaze time of the second window. Notably, if there is only one open window, the rank of that window would be ranked as the top-ranked window (because it is the only window) regardless of/independent from other user input, such as gaze, selection, etc.

In an embodiment, the rank can be determined based on the eye tracking and a selection by the user. For example, the user can select the first window having the video and looking at a description of the video playing in the same first window. In such a scenario, both the eye tracking accruing a longer gaze time (than the second window) and the user selecting the first window to make it the active window can make the first window the top-ranked window.

Thus, the rank can be determined based on one or more elements. The more elements being used, the more accurate the determination of the rank. Hence, the rank can be determined by a combination of eye or gaze tracking, an input selection by a user (for example, the user clicking on an icon or a display element in a window (the first window or the second window), a user hovering a mouse or pointer over a portion of a window (without necessarily clicking or selecting anything), etc. The rank determination can also go beyond these elements/factors to include preset settings related to a particular user and/or past behavior/experiences. For example, the user can preset certain settings and/or the user's device can learn from user's past behavior/experiences about his/her preference when two or more windows are displayed at the same time side by side.

For example, this particular user may always play a video in the first window while working on a presentation in the second window. In such case, the user's device can learn from this behavior and use this knowledge to more accurately determine the rank (for example, when the first window has a video playing and the second window corresponds to a work processing document or a presentation, the active window is likely the second window). Such knowledge can be paired with eye gaze direction and other factors such as mouse/cursor movement, etc. in order to more accurately determine the rank.

In an embodiment, in step 420, the inspected main memory data can also include a reference patch therein and the first device 701 can identify the reference patch in the main memory data. In an embodiment, the first device 701 can detect and identify the reference patch in the main memory by a value, such as a known encoding, where the format of the of the data itself can indicate to the application where the reference patch is located. For example, the known encoding can be 25 bytes long and in a predetermined position within the binary bits of the main memory. In one embodiment, the first device 701 inspects the main memory data for bit data corresponding to the reference patch. For example, the bit data corresponding to the reference patch is an array of bits corresponding to pixel data making up a reference patch. In one embodiment, the presence of the reference patch is an attribute of an object or a class. In one embodiment, the reference patch is a file used by an application wherein the file is loaded into the main memory when the reference patch is displayed by the application. In one embodiment, the presence of the reference patch is indicated in metadata, e.g., with an indicator. In an embodiment, the reference patch can be identified by parsing an application (e.g. a Word document), looking through the corresponding metadata in the computing memory space, and finding the reference patch in the metadata by attempting to match the metadata with a predetermined indicator indicating the presence of the reference patch, such as the unique identifier.

In step 425, the first device 701 can determine whether the software application corresponding to the computing memory space (and sub-memory space) in which the reference patch was identified is active or in the displayed data. Referring to the example of step 415, while the window of the first application can include the reference patch, the inactive window of the second application can become active and overlay over the window of the first application which was previously the active window. In such a scenario, the reference patch in the window of the first application can become covered by the window of the second application. As such, the content of the reference patch in the window of the first application need not be displayed or can cease being displayed. However, in an alternative scenario, the window of the first application, including the reference patch, can be active and the reference patch therein can be uncovered and visible. In one embodiment, the active window refers to the window with the most recent interaction, e.g., a click, a movement. In one embodiment, the first device 701 uses a priority list to determine which window is the active window. For example, content for a first application with higher priority than a second application will be displayed even if the second application covers the reference patch of the first application.

In step 430, upon determining the software application corresponding to the computing memory space (and sub-memory space) in which the reference patch was identified is active or in the displayed data, the first device 701 can decode the encoded data of the unique identifiers from the area of the reference patch, wherein the unique identifiers correspond to the surface area.

In step 435, the first device 701 can use the unique identifiers to link the surface area with the content using metadata and retrieve the content based on the unique identifiers.

In step 440, the first device 701 can overlay the content onto the surface area of the displayed data based on the unique identifiers.

Again, the method of identifying the reference patch included in the displayed data and augmenting the displayed data is described as performed by the first device 701, however, the second device 850, the second client/user device 702, and/or the nth device 70n can alternatively or additionally perform the same functions.

In an embodiment, the first device 701 identifies the surface area corresponding to the reference patch by employing further processes. To this end, FIG. 4B is a flow chart of a sub-method of identifying the reference patch with the unique identifiers corresponding to the surface area from the stream of data, according to an embodiment of the present disclosure.

In step 410a, the first device 701 can decode the encoded reference patch from the main memory. The encoded reference patch can include the marker that makes up the unique identifiers within the reference patch incorporated previously. The reference patch can also include other identifying information. The marker can be disposed within the reference patch, such as within the area of the reference patch or along a perimeter of the reference patch, or alternatively, outside of the area of the reference patch.

Again, whatever schema is used to encode the marker in the reference patch is also used in reverse operation to decode the underlying information contained within the reference patch. As stated above, in an embodiment, the encoded marker can be patterns generated and decoded using the ArUco algorithm or by other algorithms that encode data according to a predetermined approach.

Similarly, as described above, in step 410b, the first device 701 can also extract attributes of the surface area from the reference patch.

Similarly, as described above, in step 410c, the first device 701 can also calculate a position and size of the surface area relative to the size and shape (dimensions) of the output signal from the display that is displaying the displayed data.

Similarly, as described above, the first device 701 can provide information regarding the characteristics of the output video signal, such that the content that is later overlaid can correctly be displayed to account for various manipulations or transformations that may take place due to hardware constraints, user interaction, image degradation, or application intervention. Such manipulations and transformations may be the relocation, resizing, and scaling of the reference patch and/or the surface area, although the manipulations and transformations are not limited to those enumerated herein.

Similarly, as described above, the reference patch itself can be used as the reference for which the content is displayed on the surface area.

Similarly, as described above, the first device 701 can determine an alternative location at which to display the content based on behaviors of the user.

In an embodiment, the first device 701 employs other processes to associate the unique identifiers with the content. To this end, FIG. 4C is a flow chart of a sub-method of associating the unique identifiers with content, according to an embodiment of the present disclosure. In step 9720a, the first device 701 can send the unique identifiers to a second device 850. The second device can retrieve metadata that describes the content, the content being associated with the surface area through the unique identifiers. This can be done by querying a remote location, such as a database or a repository, using the unique identifiers of the surface area as the query key. In an embodiment, the first device 701 sends the unique identifiers to the second device and the second device associates the unique identifier of the reference patch to corresponding content based on the metadata. The metadata associated with the surface area's unique identifier can be transmitted to the first device 701 with the augmentation content.

In step 420b, the first device 701 can assemble the content that is associated with the surface area's unique identifier. The assembly can entail loading the necessary assets for assembling the content. In an embodiment, this can entail loading manipulation software or drivers in order to enable the first device 701 to process the content. Other assembling processes can be the loading of rendering information in order to transform and manipulate an individual portion of the content. Furthermore, the loaded manipulation software, drivers, or rendering information can be used to compile all the individual portions of the entire content together. In an embodiment, this can include adapting the file formats of the content, delaying the playback for the content, converting from one format to another, scaling the resolution up or down, converting the color space, etc.

In step 420c, the first device 701 can provide access control parameters for the content. The access control parameters can dictate whether the content is visible to some users, or to some geographical locations, or to some types of displays and not others, as well as the date and time or duration of time a user can access the content or is allowed to access. In an embodiment, visibility of the content can be defined for an individual. For example, the content can be a video that is appropriate for users over a certain age. In an embodiment, visibility of the content can be defined for a geographic location. For example, the content can be a video that is region-locked based on a location of the first device 701. In an embodiment, visibility of the content can be defined for a type of display displaying the displayed data. For example, the content can be VR-based and will only display with a VR headset. In an embodiment, visibility of the content can be defined for a predetermined date and a predetermined time. For example, the content can be a video that will only be made publicly available after a predetermined date and a predetermined time. In an embodiment, visibility of the content can be defined for a time period. For example, the content can be a video that is only available for viewing during a holiday. The first device 701 thus calculates the user's access level based on those parameters and provides an output result as to the user's ability to access the content, i.e., whether the content will be visible or invisible to the user. Note that the access control parameters can be global, for all the displayed data, or it can be localized per surface area and the underlying content.

Referring again to FIG. 4A, in step 440, the first device 701 can carry on the processes of overlaying the surface area with the content into the displayed data in accordance with the surface area, the position, and the size identified by the unique identifier. The first device 701 can determine or adjust the size and location of the assembled content on the surface area relative to the size and shape of the displayed data being outputted by the display. Then, the first device 701 can render the associated content (or the assembled individual portions) over the surface area's shape and perimeter using the size and location information. Thus, the content is superimposed on top of the surface area.

This methodology can be referred to as “memory vision”.

The first device 701 can continuously monitor changes that are taking place at the end user's device (such as the networked device 750 of the second user) to determine whether the reference patch and/or the surface area has moved or been transformed in any way (see below for additional description). Thus, the first device 701 can continuously inspect subsequent frames of the stream of the data (for example, every 1 ms or by reviewing every new frame), displaying the displayed data, to determine these changes. The first device 701 can further continuously decode the reference patch's data from the identified reference patch. Then the first device 701 can continuously extract attributes from the data, the attributes being of size, shape, and perimeter and comparing those changes between the current frame and last frame. Further, the first device 701 can continuously calculate the size and location of the surface area and compare changes between the size and location of the surface area from the current and the last frame and then continuously overlay the content on the surface area by incorporating the changes in the reference patch's attributes and the changes in the size and location of the surface area. As stated above, when the user manipulates his/her display device by scaling, rotating, resizing or even shifting the views from one display device and onto another display device, the first device 701 can track these changes and ensure that the content is properly being superimposed onto the surface area.

In an embodiment, the methodologies discussed with reference to FIGS. 3A-3C that use the frame buffer can be used without using the methodologies discussed with reference to FIGS. 4A-4C that use the memory space and vice-versa. In other words, in an embodiment, either the methodologies of FIGS. 3A-3C or the methodologies of FIGS. 4A-4C can be used to identifying a reference patch and overlay the content in displayed data.

However, in an embodiment, both the methodologies discussed with reference to FIGS. 3A-3C that use the frame buffer and the methodologies discussed with reference to FIGS. 4A-4C that use the memory space can be used together. In such embodiment, a device can use both approaches to accurately identify the same reference patch (applying both approaches can yield better results). In an embodiment, both approaches can be used to identify different reference patches. For example, if a document includes reference patches, the first device can apply the methodologies discussed with reference to FIGS. 3A-3C to a first reference patch, while applying the methodologies discussed with reference to FIGS. 4A-4C to a second reference patch.

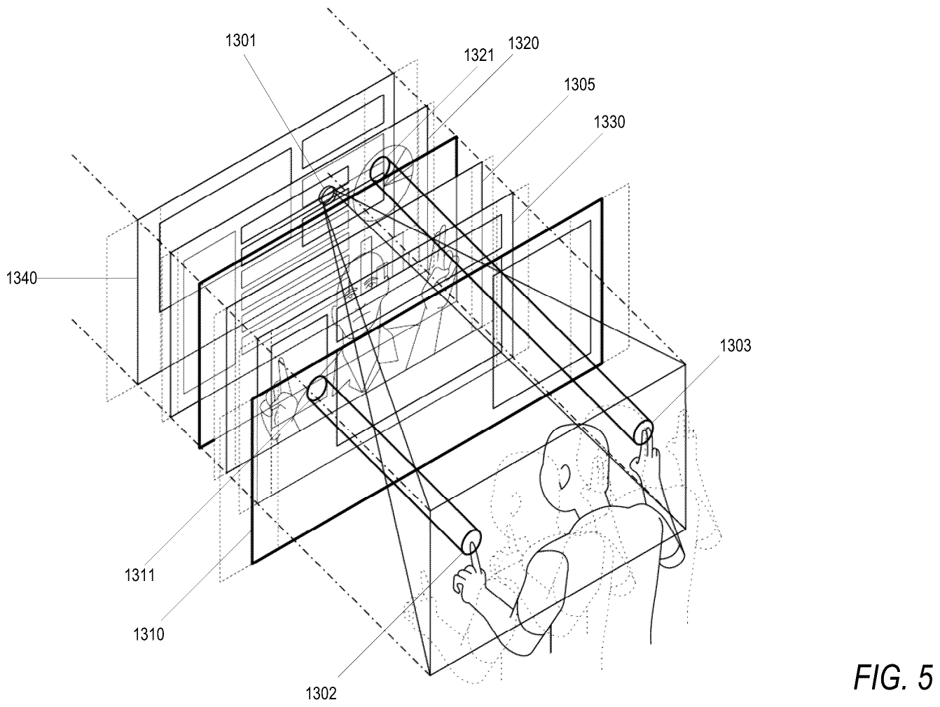

As shown in FIG. 5, in an embodiment, one or more of the disclosed functions and capabilities may be used to enable a volumetric composite of content-activated layers of transparent computing, content-agnostic layers of transparent computing and/or camera-captured layers of transparent computing placed visibly behind 2-dimensional or 3-dimensional content displayed on screens, placed in front of 2-dimensional or 3-dimensional content displayed on screens, placed inside of 3-dimensional content displayed on screens and/or placed virtually outside of the display of screens. Users can interact via touchless computing with any layer in a volumetric composite of layers of transparent computing wherein a user's gaze, gestures, movements, position, orientation, or other characteristics observed by a camera are used as the basis for selecting and interacting with objects in any layer in the volumetric composite of layers of transparent computing to execute processes on computing devices.

In an embodiment, one or more of the disclosed functions and capabilities may be used to enable users to see a volumetric composite of layers of transparent computing from a 360-degree optical lenticular perspective wherein a user's gaze, gestures, movements, position, orientation, or other characteristics observed by cameras are a basis to calculate, derive and/or predict the 360-degree optical lenticular perspective from which users see the volumetric composite of layers of transparent computing displayed on screens. Further, users can engage with a 3-dimensional virtual environment displayed on screens consisting of layers of transparent computing placed behind the 3-dimensional virtual environment displayed on screens, placed in front of a 3-dimensional virtual environment displayed on screens, and/or placed inside of the a 3-dimensional virtual environment displayed on screens wherein users can select and interact with objects in any layer of transparent computing to execute processes on computing devices while looking at the combination of the 3-dimensional virtual environment and the volumetric composite of layers of transparent computing from any angle of the 360-degree optical lenticular perspective available to users.

In one embodiment, a camera 1301 can be used to capture image or video data of a user interacting with the volumetric composite. The camera 1301 can be integrated into or connected to a device displaying the layers of the volumetric composite. In one embodiment, the volumetric composite can include a camera-captured layer 1305, wherein the camera-captured layer 1305 can include the image or video data of the user captured by the camera 1301. In the illustrative example of FIG. 5, the camera-captured layer 1305 can be placed visibly behind a first layer 1310 and in front of a second layer 1320. The first layer 1310 can be a content-activated layer or a content-agnostic layer. The second layer 1320 can be a content-activated layer or a content-agnostic layer. In one embodiment, the camera-captured layer 1305 can be partially transparent. In one embodiment, the first layer 1310 can be partially transparent to enable the visibility of the camera-captured layer 1305 and the second layer 1320 behind the first layer 1310. In one embodiment, the image or video data captured by the camera 1301 and displayed in the camera-captured layer 1305 can be used to interact with content on the first layer 1310 and/or the second layer 1320. For example, the first layer 1310 and the second layer 1320 can include 2-dimensional or 3-dimensional content. In one embodiment, the 3-dimensional content can include content from more than one layer.

In one embodiment, content in the camera-captured layer 1305 can be used to trigger actions in the first layer 1310 and/or the second layer 1320. In one embodiment, the first layer 1310 and the second layer 1320 can be content-activated layers. As an example, the camera 1301 can capture video data of a user at a first location 1302. In one embodiment, the first location 1302 can be a location in three-dimensional space. In one embodiment, the first location 1302 can be located in a frame of the camera-captured layer 1305. In one embodiment, the action in the video data can be identified via inspection of the frame buffer, as is described in greater detail herein. The action of the user at the first location 1302 can be used to trigger an interaction with the first layer 1310, wherein the interaction with the first layer 1310 can be executed at a target location 1311 in the first layer 1310. In one embodiment, the target location 1311 can be determined based on the first location 1302 of the action. In one embodiment, the target location 1311 can be determined based on the 2-dimensional or 3-dimensional in the first layer 1310. In one embodiment, the target location 1311 can be determined based on the image or video data captured by the camera 1301, including, but not limited to, a user location, a user gaze, or a user action. In one embodiment, the video data captured by the camera 1301 can include video data of a user at a second location 1303. In one embodiment, the second location 1303 can be a location in three-dimensional space. In one embodiment, the second location 1303 can be located in a frame of the camera-captured layer 1305. The action of the user at the second location 1303 can be used to trigger an interaction with the second layer 1320, wherein the interaction with the second layer 1320 can be executed at a target location 1321 in the second layer 1320. In one embodiment, the interaction with the second layer 1320 can be executed without an effect on the first layer 1310. In one embodiment, the target location 1321 can be based on the second location 1303. For example, the interaction can be a selection of a graphic at the target location 1321 in the second layer 1320.

In one embodiment, the volumetric composite can include additional layers, including, but not limited, to a third layer 1330 and a fourth layer 1340. In one embodiment, the layers in the volumetric composite can be placed in any order. For example, the third layer 1330 can be in between the first layer 1310 and the second layer 1320, while the fourth layer 1340 can be behind the second layer 1320. According to one embodiment, the third layer 1330 and the fourth layer 1340 can be content-agnostic layers. The 2-dimensional or 3-dimensional content in the third layer 1330 and the fourth layer 1340 may not be affected by actions identified in the video data and the camera-captured layer. In one embodiment, the order of the layers can change in the volumetric composite. In one embodiment, the order of the layers may affect the transparency and/or visibility of 2-dimensional or 3-dimensional content in one or more of the layers. In one embodiment, a layer can become a content-activated layer, a content-agnostic layer, or a camera-captured layer. For example, the third layer 1330 can become a content-activated layer and the second layer 1320 can become a content-agnostic layer. The combination of content-activated layers and content-agnostic layers can create an interactive volumetric composite.

An illustrative example will now be discussed: a scenario where a user (for example, a user at the first device 701) receives (from another device such as the third device 702) an email with the embedded reference patch in the body of the email or as an attached document. The reference patch within the displayed data (email) can show a facade of the content or the reference patch. The application on the first device 701 can scan the display to find the reference patch and the surface area and the attributes within the displayed data as it is being displayed. Furthermore, the first device 701 can access the content using the unique identifier and metadata and prepare it for overlaying. At which point, the user (i.e., the recipient) can select the content by various ways such as by clicking on the content's facade or the surface area, or otherwise indicating that it intends to access the content.

Thereafter, the content can be retrieved from the second device 850 using the unique identifier and the metadata saved within a database that directs the second device 850 to where the content is saved and can be obtained. That is, the second device 850 can determine the content corresponding to the derived unique identifier and send the content corresponding to the unique identifier (and the metadata) to the first device 701. Then, the first device 701 can superimpose (overlay) the content on the surface area. While the content is being received and overlayed on the surface area, the first device 701 can continually monitor the location, size and/or shape of the reference patch and/or the surface area to determine movement and transformation of the reference patch and/or the surface area. If the user has moved the location of the reference patch and/or the surface area, or has resized or manipulated the screen for whatever purpose, the new location, shape and/or size information of the reference patch and/or the surface area is determined in order to display the content properly within the bounds of the surface area. Thus, the content moves with the displayed data as the displayed data is moved or resized or manipulated.

In an embodiment, a user that has received the displayed data embedded with the reference patch can access the content on his/her first device 701, as described above. The user may want to transfer the ongoing augmenting experience from the first device 701 to another device, such as the device 70n, in a seamless fashion. In that scenario, the user is able to continue the augmenting experience on his/her smartphone, smartwatch, laptop computer, display connected with a webcam, and/or tablet pc. The user therefore can capture the embedded reference patch and therefore the encoded attributes, as the content is being accessed and overlaid unto the surface area. The user can capture the embedded reference patch by taking a picture of it or acquiring the visual information using a camera of the third device 702 as mentioned above. The user can capture the embedded reference patch by accessing the main memory of the second client/user device 702 as mentioned above.

Assuming the user also has the functionality included or the application installed or running on the device 70n, the device 70n would recognize that an embedded reference patch and encoded unique identifiers are in the captured image/video stream or in the main memory of the device 70n, such as in the corresponding computing memory space as the software application currently active on the device 70n. Once the surface area has been determined and the reference patch decoded, the content can be obtained from the second device 850, using the unique identifiers and the metadata and then overlaid on the surface area within the displayed data displayed on the device 70n. In an embodiment, as soon as the device 70n superimposes the content onto the surface area, the second device 850 or the backend determines that the stream has now been redirected onto the device 70n and thus pushes a signal to the first device 701 to stop playing the content on the first device 701. The device 70n that is overlaying the content therefore resumes the overlaying at the very same point that the first device 701 stopped overlaying the content (for instance, when the content is a video for example). Thus, the user is able to handoff the content from one device to another without noticing delay or disruption in the augmenting experience.

In one embodiment, the visibility of the content is dynamic and can be adjusted. For example, in one context an augmentation overlaps with another image and obscures the image by being displayed in front of the image. At a later time, the augmentation is displayed behind the image such that the image obscures the augmentation when the augmentation is no longer needed. In one embodiment, the transparency of an augmentation can be adjusted to show objects in the same location as the augmentation. In one embodiment, the interactive properties of content are also dynamic and can be modified. Click-ability refers to whether an object can be clicked or otherwise activated by a trigger, thus causing an action to be performed. The action includes, but is not limited to, sending data, receiving data, and/or modifying display content. When the click-ability of an object is on, the trigger causes the action to be performed. When click-ability of an object is off, the trigger does not cause the action to be performed. Touch-ability is a subset of click-ability wherein the trigger is a touch using a touch panel. The trigger can be collected by an input device, including, but not limited to, a mouse, a keyboard, a touch panel, a camera, and/or a microphone.

The click-ability of any augmentation layer and/or object of content can be modified. In one embodiment, the click-ability of an object in a layer can be modified independently of other objects in that layer. For example, only one button is active (clickable) while other buttons in the augmentation are not active. In addition, objects in different layers can simultaneously be clickable. For example, the original displayed data is a slide deck wherein a slide in the slide deck includes a button for proceeding to a next slide. The slide includes a reference patch, and an electronic device identifies the reference patch and displays an augmentation including a multiple-choice survey. The answers to the multiple-choice survey and the button for proceeding to the next slide are all clickable, enabling a user to interact with the augmentation as well as the original displayed data. In another embodiment, the button for proceeding to the next slide is not clickable until an answer to the multiple-choice survey has been collected. Thus, inputs and interactions on one layer can be used to affect another layer. In one embodiment, transparency and click-ability can be adjusted at a pixel level. For example, if an object is partially obscured, only the visible part of the object is clickable.

In one embodiment, click-ability and transparency can be connected. For example, a first clickable object in a first layer and a second clickable object in a second layer are located on the same surface area of a display. The click-ability of the first clickable object is on and the click-ability of the second clickable object is off for a period of time. During this period of time, the second clickable object is transparent and only the first clickable object is visible on the display. After the period of time elapses, the click-ability of the first clickable object is turned off, while the click-ability of the second clickable object is turned on. Accordingly, the first clickable object is then transparent while the second clickable object is not transparent. The transparency and click-ability of the objects can be set independently of the order in which layers are created, edited, retrieved, and/or displayed. In another example, an electronic device displays a full-screen Microsoft PowerPoint® presentation and full-screen scrolling speaker's notes at the same time in one window, wherein the click-ability of any of the pixels of the presentation and the notes can be adjusted to be on or off. The result is a multi-layered content stack experience wherein attributes such as transparency and click-ability for any layer in the stack can be adjusted at the pixel level.

In one embodiment, pixels in one layer can have click-ability on, while pixels in the remaining layers can have click-ability off. Further, portions of pixels within layers that have click-ability off can have their click-ability turned on, while the remaining pixels in that layer remain off (and vice versa). The determination of which pixels have click-ability on and off can be determined based on parameters including, but not limited to, user settings, hot spots, application settings, user input. Hot spots can refer to regions of a computer program, executed by circuitry of a device, where a high percentage of the computer program's instructions occur and/or where the computer program spends a lot of time executing its instructions. Examples of hot spots can include play/pause buttons on movies, charts on presentations, specific text in documents, et cetera.

Referring back to the displayed data discussed above, in an example, the displayed data can be a page of a website. The webpage may be dedicated to discussions of strategy in fantasy football, a popular online sports game where users manage their own rosters of football players and points are awarded to each team based on individual performances from each football player on the team. After reading the discussion on the website page, the user may wish to update his/her roster of football players. Traditionally, the user would be required to open a new window and/or a new tab and then navigate to his/her respective fantasy football application, to his/her team, and only then may the user be able to modify his/her team. Such a digital user experience can be cumbersome. With augmentation, however, the user may not need to leave the original webpage since a reference patch corresponding to a fantasy football augmentation (i.e., fantasy football content for overlaying on the displayed website page) may be positioned within the viewable area of the website page. The corresponding content may be, for instance, an interactive window provided by a third-party fantasy football application that allows the user to modify his/her roster without leaving the original website. Thus, instead of navigating to a different website and losing view of the informative fantasy football discussion, the user can simply interact with the content that is being overlaid on the displayed data.

The above-described augmentations are particularly relevant to environments where the underlying content is static. Static content may include textual documents or slide decks. Often, the static content is stored locally in the electronic device. Due to its nature, the static content is not capable of being dynamically adjusted according to complex user interactions, in real-time, during the user experience.

Such a dynamic environment includes one where, for instance, a video conversation is occurring. A first participant of the video conversation may share their screen with a second participant of the video conversation and wish to remotely-control the content on a display of a device of the second participant. By including the reference patch within the displayed data that is being shared, which may be the video itself or another digital item, where sharing the displayed data includes transmitting the displayed data over a communication network from the first participant to the second participant, the second participant may be able to experience the content when the device of the second participant receives the transmitted displayed data and processes it for display to the user.

Generally, and as introduced in the above example of a dynamic environment, the reference patch 104 can be inserted into displayed data displayed on a first computer or the first device 701. The display of the first device 701 can be streamed to a second computer or the third device 702. In an example, the third device 702 decodes the streamed display of the first device 701 and, based on the identified presence of the reference patch 104, can locally-augment the display of the third device 702 to overlay the intended content on the streamed display of the first device 701. The design and the arrangement of the content can be provided relative to the reference patch 104 placed into the displayed data on the first device 701. The content can include objects to be displayed and may be configured to display different subsets of objects based on interactions of a user with the content. The objects, therefore, may be interactive. In one embodiment, the second computer can retrieve the augmentation from a server. Thus, the augmentation is not included directly in the displayed data streamed from the first computer to the second computer but is retrieved and included in the display at a later time. In one embodiment, the unique identifier included in the reference patch provides further information and/or instructions for retrieving the augmentation.

In an example of a live video stream, a user may be a yoga instructor teaching a remote yoga class by Microsoft Teams. Each participant in the class may be able to view the yoga instructor via their respective devices, wherein the ‘live streamed’ video includes video of the yoga instructor guiding the participants of the class through the techniques. At the end of class, the yoga instructor may wish to receive payment from each of the participants. The instructor may open a cloud-based slide which, for instance, may have the reference patch 104, therein. The reference patch 104 may be configured to augment a pay button relative to a position of the reference patch 104 on a device display of each participant. Upon screen sharing the cloud-based slide with the participants in the class, each participant's device receives the transmitted displayed data and processes the displayed data for display. During processing, each device observes and identifies the reference patch 104 within the displayed data. Accordingly, each device can generate a local augmentation (i.e., retrieve and display the corresponding content) on a respective display in order for the participant to be able to enter the payment information and pay for the remote yoga class. The content may be generated within the live video stream.

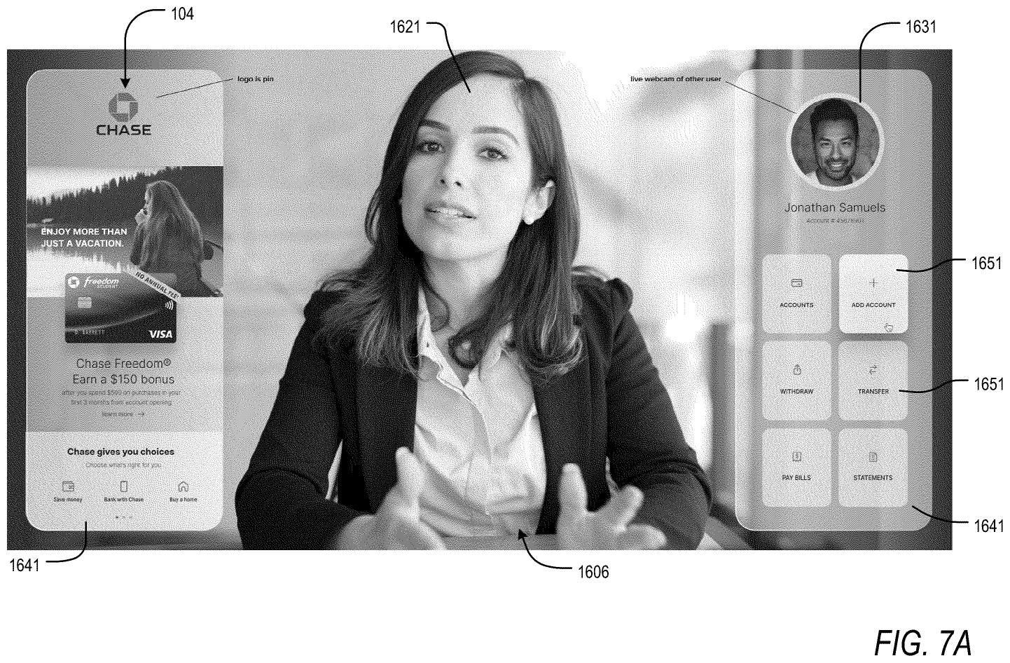

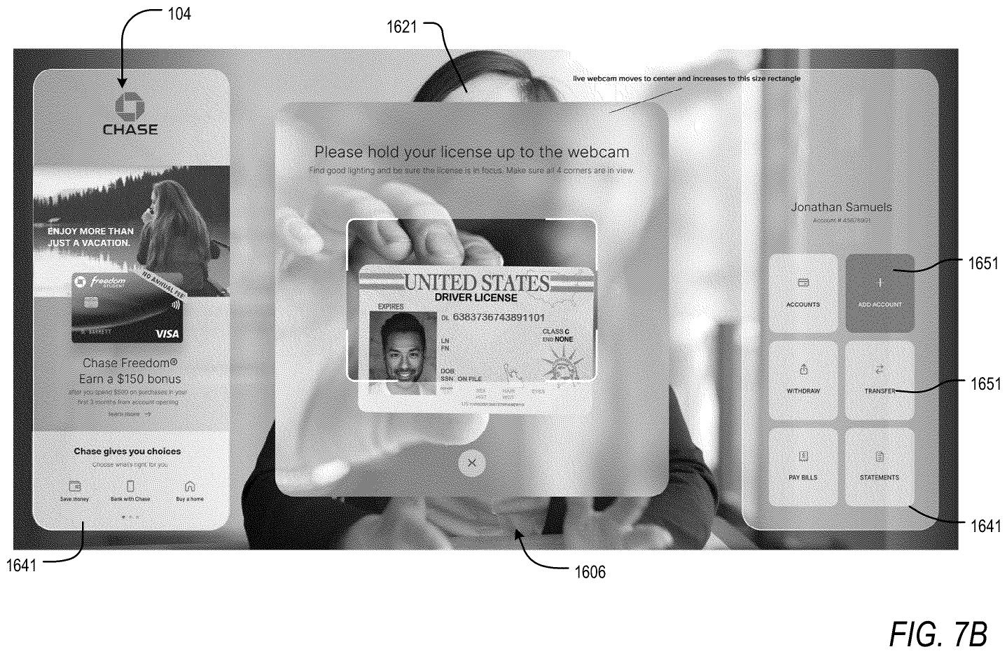

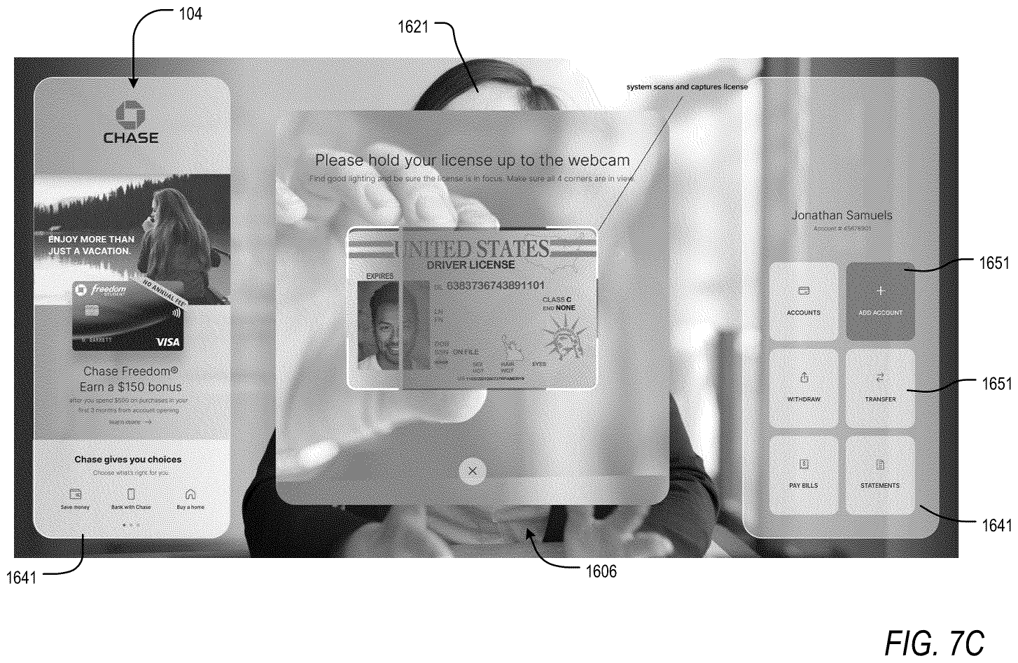

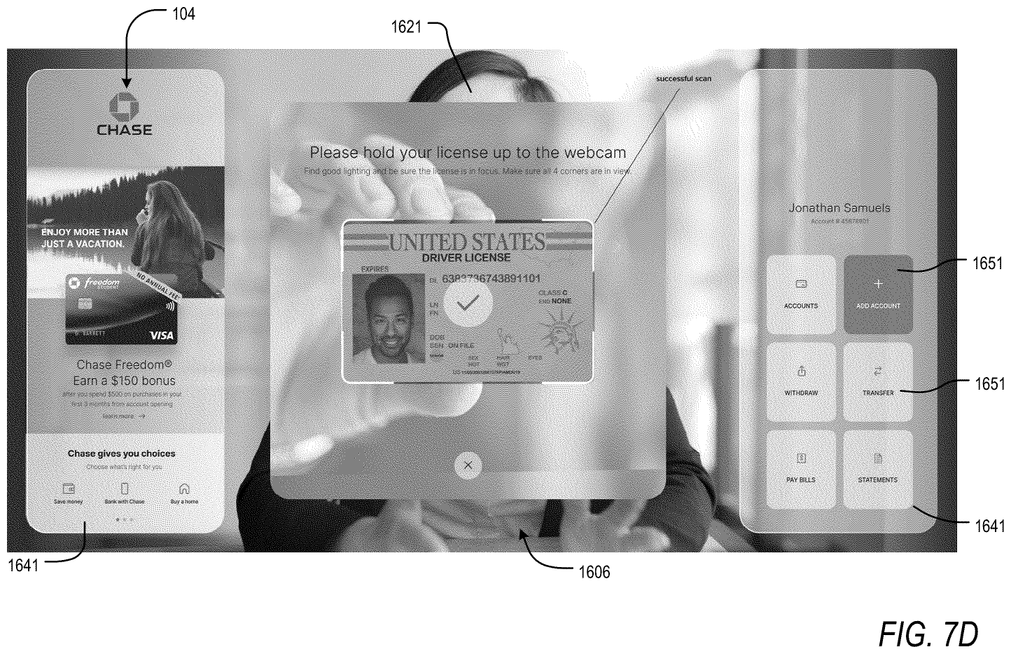

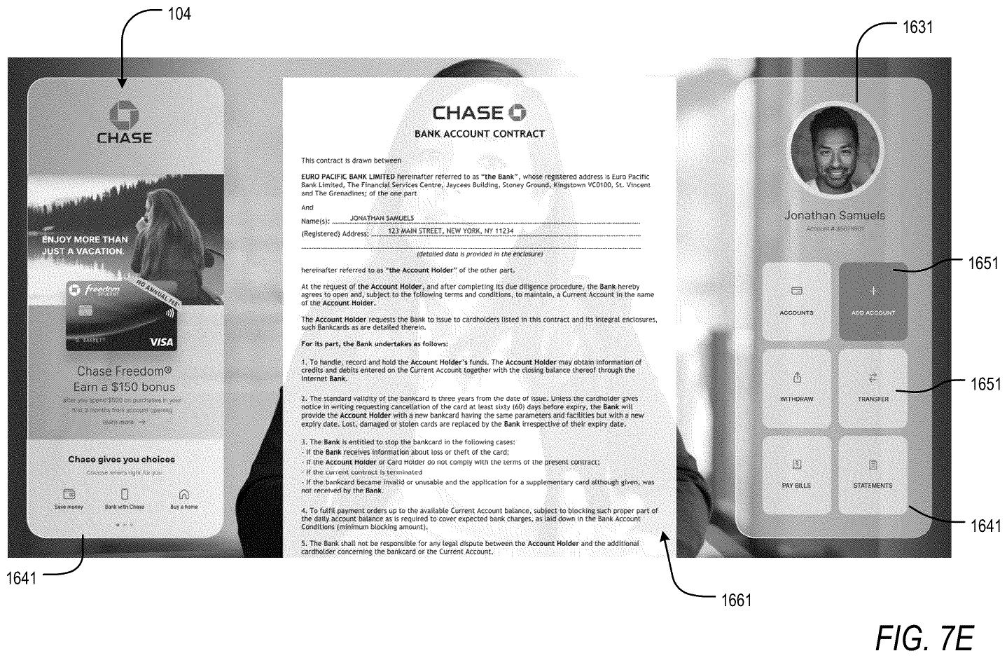

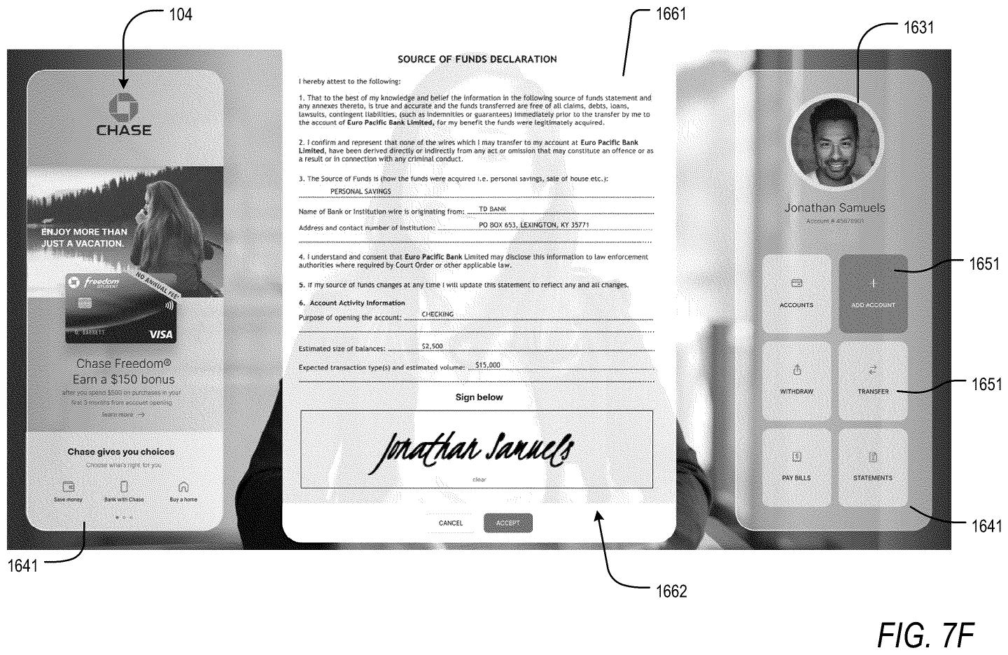

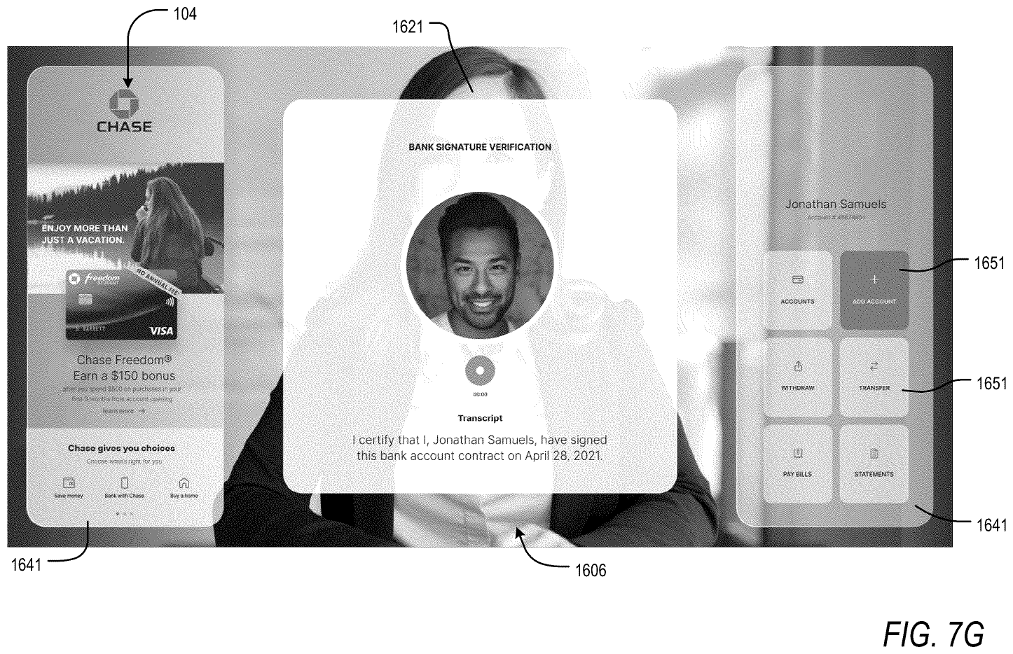

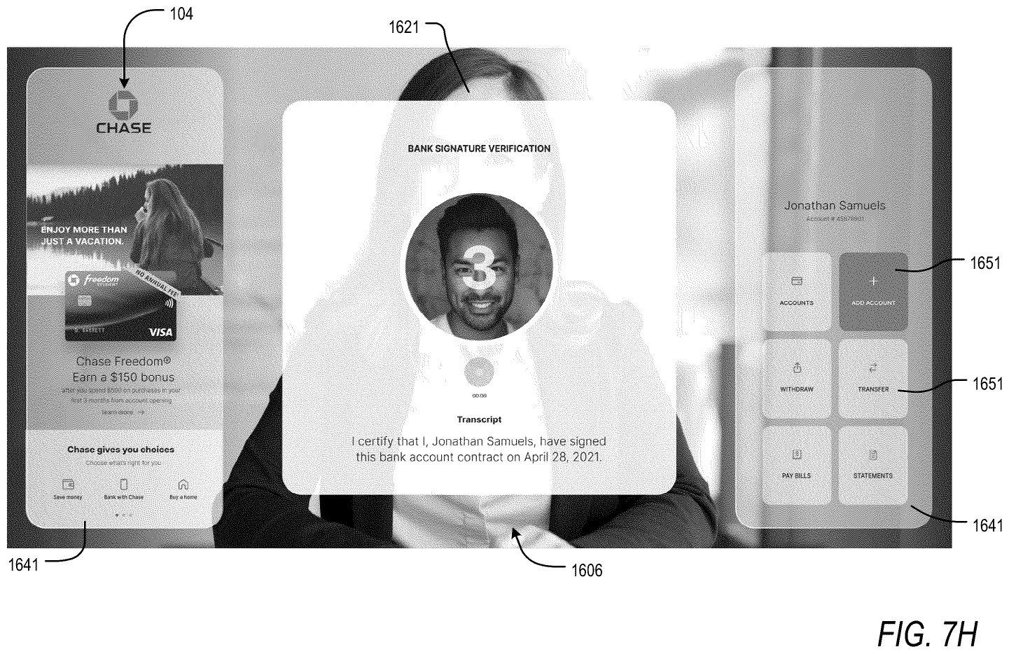

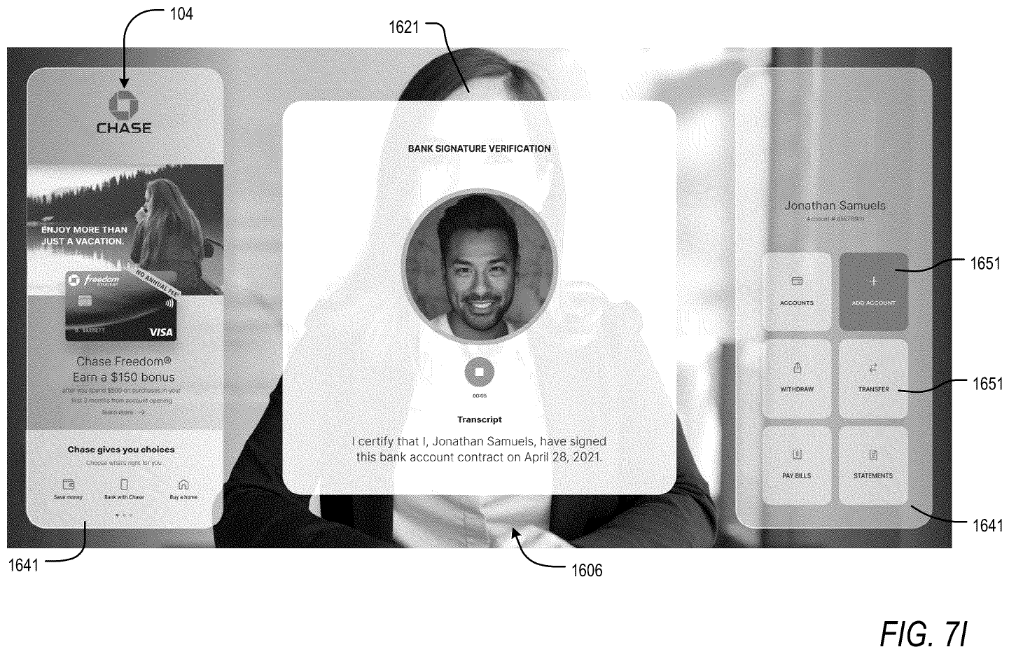

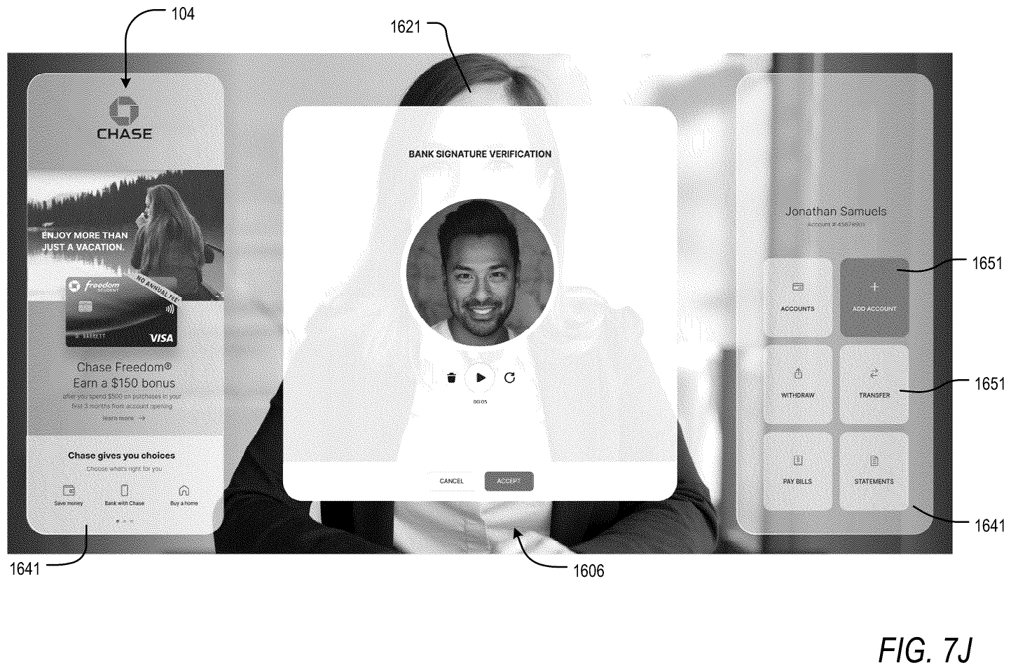

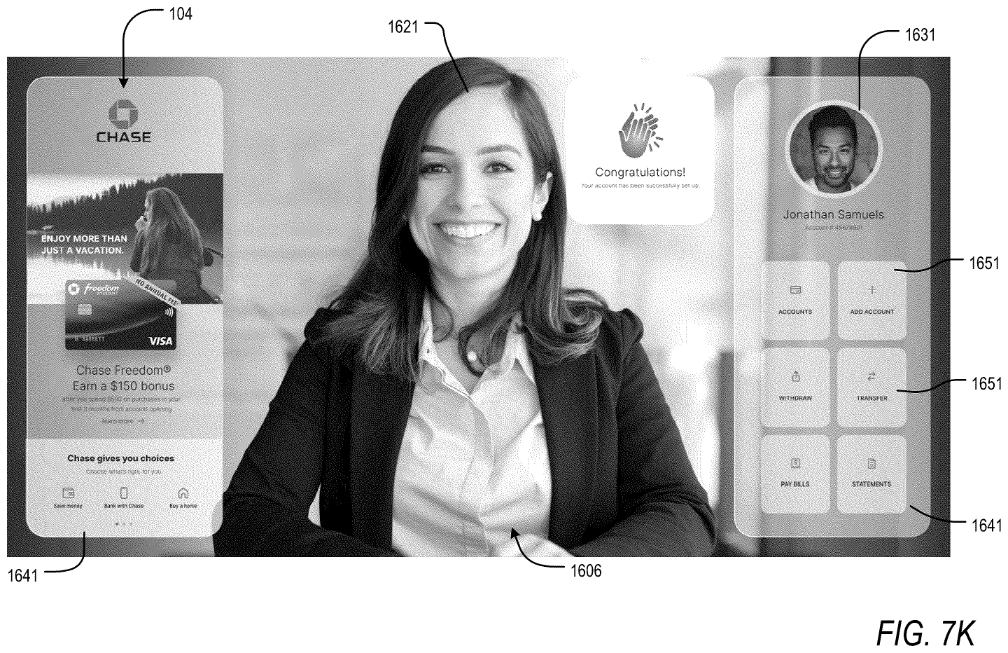

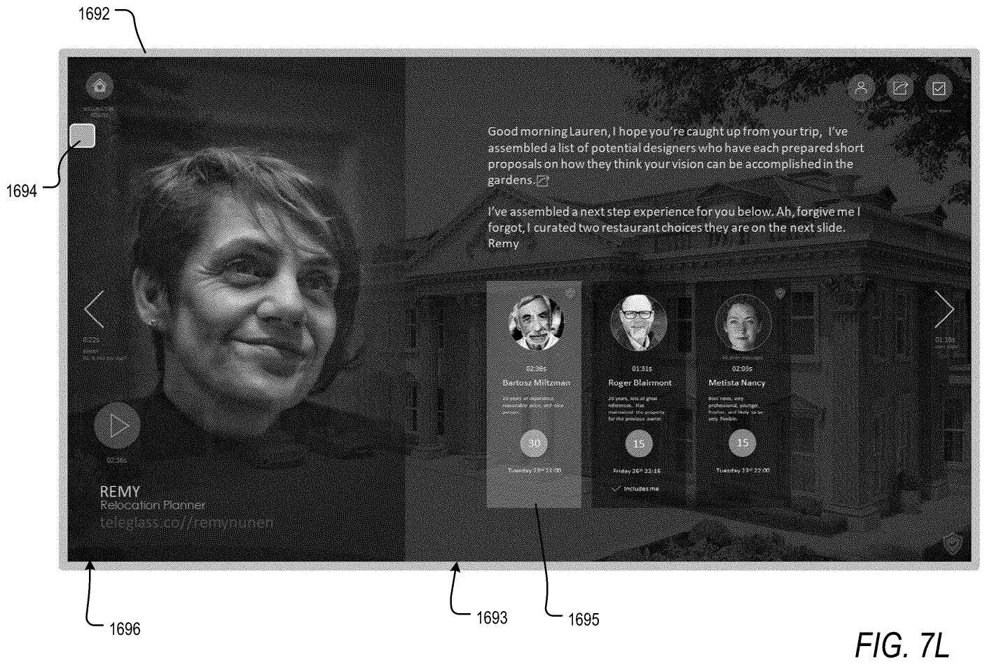

In another example of a live video stream, and as will be described with reference to FIG. 7A through FIG. 7K, a user may be a bank teller discussing a new savings account with a potential bank member. The bank teller may initiate a video call with the potential bank member. The bank teller may include, within a video stream being transmitted from the bank teller to the potential bank member, the reference patch 104. The transmitted video stream may include a video feed generated by a camera associated with a device (the first device 701) of the bank teller. Accordingly, the transmitted video stream may include an image of, for instance, a face of the bank teller and the reference patch 104 therein. Upon receiving the video stream, a device of the potential bank member (the third device 702) may process the video stream and identify the reference patch 104. Accordingly, the third device 702 of the potential bank member may generate a local augmentation (i.e., retrieve and display the corresponding content) on the respective display of the third device 702 in order to allow the potential bank member to be able to interact with the bank teller and establish the new savings account. The content may appear on top of the live video stream of the bank teller. The content can include a number of objects to be displayed and may be configured to display different subsets of objects based on interactions of a user with the content, the objects being interactive in some cases. This allows for the content to be updated in response to user interactions.

For instance, updated content may reflect a step by step process of opening the new savings account, the content being updated at each step according to the interactions of the potential bank member. First, the content may require confirmation of identity, which can include instructing the potential bank member in exhibiting his/her driver's license such that an image of the driver's license can be obtained. The confirmation of identity may also include instruction related to and acquisition of an image of the potential bank member. Next, the content may present a banking contract to the potential bank member, the potential bank member then being able to review and sign the banking contract. Lastly, the content can request the potential bank member provide verbal confirmation of the approval of the bank contract. Each of these steps can be associated with a same reference patch 104 corresponding to content that guides the ‘new’ bank member along the account setup process.

With reference now to FIGS. 6A through 6C, an exemplary implementation of a slide deck video augmentation will be described in more detail. In the exemplary implementation, a slide deck 601 is being displayed by the Nth user device 70n. The currently displayed slide 602 corresponds to the title slide of the slide deck. The file data 603 associated with the slide deck is shown being accessed by the Nth user device 70n. This data includes the reference patch 104 described above. This data can also include an indicator which indicates the presence of a reference patch on slide 5, which is not yet displayed in the displayed data. It should be noted that the indicator can be in the data of the file or in metadata associated with the file. It should also be noted that the file data 603 associated with the slide deck can be accessed from a local location (i.e., one which is part of the Nth user device 70n such as a main memory, a GPU, a CPU, a hard drive, a solid state drive, flash memory, or other similar such component or location) or can be accessed from a location remote to the Nth user device 70n, a remote device, such as the second device 850 as described above (e.g., a cloud device, server, or the like). In FIG. 6A, the file data 603 is shown as residing on a local hard drive of the Nth user device 70n.

The file data 603 can optionally also include an instruction for pre-retrieval of secondary content or the Nth user device 70n can be configured to perform pre-retrieval of secondary content. Such pre-retrieval can be accomplished by transmission of transmitted data 604 to a remote device (e.g., the second device 850) at which secondary content is located. Such transmitted data 604 can be or include data that relates to the location address of the secondary content at the remote device, data that relates to the identity of the secondary content, data that relates to a type of the secondary content (e.g., image, video, 3D model, etc.), data relating to an availability of the secondary content at the remote device (e.g., data for or related to a “content check” as described below), data providing an instruction for the remote device to prepare the secondary content for transmission to the Nth device, data providing an instruction for the remote device to initiate a transfer of the secondary content to the Nth device, or any other suitable data related to or enabling any of the processes or features described below, or a combination thereof. In FIG. 6B, the currently displayed slide 602 corresponds to slide 5, on which the reference patch 104 resides. It should be noted that the reference patch may not be visible to the naked eye of a user yet still be detectable as described herein. The Nth user device 70n can optionally receive a transmission from the remote device, the transmission including received data 606 which corresponds to the secondary content. Such received data 606 can be or include data corresponding to the secondary content, data corresponding to the outcome of a content check (e.g., indicated the secondary content is available or indicating that the secondary content is not available), data corresponding to an output associated with a ready request such as a ready response indicating the secondary content is ready for delivery, data related to or indicating a permission associated with the secondary content, or any other suitable data related to or enabling any of the processes or features described below, or a combination thereof It should be noted that received data 606 can be received by the Nth user device 70n even before the reference patch 104 is displayed as part of the pre-retrieval process described further below.

In FIG. 6C, an augmented version of the slide deck 601 is shown, where the secondary content 607 corresponding to or indicated by the reference patch 104 is displayed on the slide. It should be noted that in this example, the reference patch 104 is no longer displayed as it is obscured by the secondary content, but this need not be the case in all embodiments. The reference patch 104 may still be present in the file data 603 or be detectable by a suitable method described above which is compatible with detection of the reference patch if it is not currently displayed. Such pre-retrieval can also be accomplished by the retrieval of the secondary content from a local location. The content can be located and prepared for display at a remote location.

With reference now to FIG. 7A through FIG. 7K, an exemplary implementation of a live stream video augmentation will be described in more detail. In the exemplary implementation, a bank teller 1621 (e.g., on the first device 701) discusses a new savings account with a potential bank member 1631 (e.g., on the third device 702). The bank teller 1621 may initiate the video call with the potential bank member 1631. The bank teller 1621 may include, within a video stream being transmitted from the bank teller to the potential bank member 1631, the reference patch 104. In the example of FIG. 7A, the reference patch 104 is a bank logo (in this case, a Chase logo). The transmitted video stream may include a video feed 1606 generated by a camera associated with the first device 701 of the bank teller 1621. Accordingly, the transmitted video stream may include an image of, for instance, a face of the bank teller 1621 and the reference patch 104 therein. Upon receiving the video stream, the third device 702 of the potential bank member 1631 may process the video stream and identify the reference patch 104 within this video stream.

Accordingly, the third device 702 of the potential bank member 1631 may obtain rendering instructions for content 1641 (i.e., an augmentation) corresponding to the reference patch 104 and then retrieve and display the content 1641 at/on the surface area on a respective display of the third device 702 in order to allow the potential bank member 1631 to be able to interact with the bank teller 1621 and establish the new savings account. The content 1641 may be generated on top of the live video stream 1606 of the bank teller 1621. The content 1641 can include a number of objects 1651 to be displayed and may be configured to display different subsets of objects based on interactions of the potential bank member 1631 with the content 1641, the objects 1651 being interactive in some cases. This allows for the content 1641 to be updated in response to user interactions. Note that the content can be retrieved from a server such as the second device 850.

For instance, updated content may reflect the step by step process of opening the new savings account, the content being updated at each step according to the interactions of the potential bank member. With reference to FIG. 7B through FIG. 7D, the content 1641 may first require confirmation of the identity of the potential bank member 1631. This can include instructing the potential bank member 1631 to exhibit his/her driver's license such that an image of the driver's license can be obtained. As shown in FIG. 7C, a guide can be deployed and a confirmation graphic can be displayed, as in FIG. 7D, when an adequate image of the driver's license has been obtained. The confirmation of identity may also include instruction related to and acquisition of an image of the potential bank member 1631. Next, the content 1641 may present a banking contract 1661 to the potential bank member 1631, as shown in FIG. 7E. As shown in the FIG. 7F, the potential bank member 1631 may then review and provide a signature 1662 if the banking contract 1661 is approved. Lastly, the content 1641 can request the potential bank member 1631 to provide verbal confirmation of the approval of the banking contract 1661.

As shown in FIG. 7G, the potential bank member 1631 may be prompted with a transcript that is to be read back and recorded via the content 1641 to confirm the approval of the potential bank member 1631. As shown in FIG. 7H and FIG. 7I, the potential bank member 1631 may instructed by a countdown and an indication of live recording. FIG. 7J illustrates an aspect of the content 1641 that allows the potential bank member 1631 to review the recorded spoken transcript approving the bank contract 1661. Once completed, as shown in FIG. 7K, the content 1641 can display a congratulatory graphic and welcome the newest member of the bank. Each of these steps can be associated with a same reference patch corresponding to content that guides the new bank member along the account setup process via the third device 702.

According to an embodiment, the above examples allow for live streaming of data from one device to another (or many others), where frames of the data stream include the reference patch. The data stream could be a display of a cloud-based slide within a live video, a webcam feed, or other similar data source. The streamed reference patch can be recognized by (processing circuitry of) the first device 701 receiving the data stream and can initiate retrieval and displaying of content associated with the reference patch. Device(s) receiving the streamed data, which may be a screen share, a live webcam feed, and the like, can then render the content locally on the device(s).

Further to the above, the reference patch may be used to generate content for a variety of implementations. Such implementations can include renewing a motor vehicle driver's license, signing a contract, obtaining a notarization from a notary public, renewing a travel document, and the like.

In another example, as will be described with reference to FIG. 7L, the displayed data can be a slide deck. The slide deck may be generated by a concierge-type service that seeks to connect a client with potential garden designers. As in FIG. 7L, the slide deck may be presented to the client within a viewable area 1693 of a display 1692. The presently viewable content of the slide deck within the viewable area 1693 of the display 1692 may be a current frame 1696 of displayed data. Traditionally, the slide deck may include information regarding each potential garden designer and may direct the client to third-party software applications that allow the client to contact each designer. In other words, in order to connect with one or more of the potential garden designers, the client, traditionally, may need to exit the presentation and navigate to a separate internet web browser in order to learn more about the garden designers and connect with them. Such a digital user experience is cumbersome and inefficient. With augmentation, however, the client need not leave the presentation in order to set up connections with the garden designers. As shown in FIG. 7L, the reference patch 1694 may correspond to one or more augmentations 1695 and, when the reference patch 1694 is displayed, the augmentations 1695 are displayed and brought to life. The one or more augmentations 1695 can include, as shown in FIG. 7L, interactive buttons, images, videos, windows, and icons, among others, that allow the client to interact with the secondary content and to, for instance, engage with the garden designers without leaving the presentation. In an example, the interactive augmentations 1695 may allow for scheduling an appointment with a given garden designer while still within the slide deck. In one embodiment, the augmentations are only presented when the reference patch is included in the displayed data. In one embodiment, the reference patch identifies the content of the augmentation. The content of the augmentations is visually integrated into the displayed data.

It can be appreciated that the present disclosure is not limited to the above-described examples. In these examples, the user of the first device 701 may act in a manner of remote control. In one instance, the yoga instructor can remotely control an experience for his/her students. In another instance, the bank teller can remotely control an experience for the new account owner. In the instance of the yoga instructor, the remote control is provided between many devices, where the yoga instructor is able to control an experience of one or more participants from a single first device 701. However, in the instance of the bank teller, the remote control is provided between only two devices, where the bank teller is able to control the display of the new account owner.

In an embodiment, there may be synchronized experiences between only two devices and/or a synchronized experience from one device to many devices. For example, two individuals may play chess over live video of the competitor. This is a synchronized experience between only two devices. Similarly, five friends may watch a live football game on separate devices, where the betting experience content (e.g., DraftKings, etc.) is overlaid on each of their devices. A synchronized experience may be shared amongst the devices. In other words, this is a synchronized experience from one device to many devices, wherein the one device is generated by the host of the football game stream.

According to an embodiment, the reference patch can be inserted into, as part of the displayed data, recorded video that is to be displayed on the first device 701. In an example, the first device 701 decodes the recorded video and, based on the identified presence of the reference patch, can locally-augment the display of the first device 701 to overlay the intended content on the recorded video. The design and the arrangement of the content can be provided relative to the reference patch placed into the displayed data. The reference patch may be placed into the displayed data, or recorded video, by the original content creator or by another party that wishes to enhance the user visual experience.

In an example, a music video having the reference patch may be played over a video player (e.g., Vimeo) by a fan. The reference patch may retrieve and display content that makes it possible for the fan to purchase tickets to the artist's next live concert that is within a predefined radius of a current address, home address, or other address associated with the fan. Here, the live concerts that are loaded in the content over the music video, that is being played over the video player, is personalized to each fan and their respective location. The reference patch allows the live concert data to be loaded in real time.

In another example, a recorded educational video from, for instance, Khan Academy can have the reference patch that triggers a quiz for a student watching the video. In this way, the video can be paused while the content is rendered, and the student completes the quiz within the content. Once the quiz has been completed, the student may proceed to the next segment of the video.

In the above recorded video examples, the reference patch can be placed within recorded streams of data. A decoder present at the end user device can be used to identify the reference patch and then locally augment the display of the end user device to allow for dynamic user interaction with the content of the recorded video.

In an embodiment, the content can be the same for all viewers of the recorded video. In an embodiment, the content may be personalized for each viewer of the recorded video. The content can be live and updated in real time (or at the same time scale as the recorded video). The content can be attended or non-attended. In other words, a version of the educational video may have a teacher live remote controlling the experience.

In an embodiment, the reference patches can be included in the displayed data. That is, the display of the first device 701 need not only display just one of the reference patches on the display at any given time. For example, the slide deck can include three reference patches on a single slide that is being displayed in the displayed data. Each reference patch of the three reference patches can be detected and processed by the first user device 701. In an embodiment, the multiple reference patches can have a priority for displaying the corresponding content on the displayed data. The priority can be based on a determined theme of the displayed data detected by the first device 701, or based on an assigned priority value, or a combination thereof, among others. For example, a first reference patch can be an area of the user's face in an image of the user in a slide and have the highest priority, a second reference patch can be an area of a logo of a company employing the user in the slide and have the second-highest priority (by the user device 701), and a third reference patch can be the bottom-right area of the slide and have the third-highest priority. The highest priority of the first reference patch can be assigned to always have the highest priority, while the second reference patch and the third reference patch can have priorities that are not assigned and thus determined by the user device 701 based on a relation to content in the displayed data.

The presence of a reference patch within a file or webpage can be detected within the data of a file or webpage. It should be noted here that detecting the presence of a reference patch within a file or webpage is distinct from detecting a reference patch that is being displayed in display data. There is no requirement that the file or website be displayed and/or visible in order to detect the presence of the reference patch. The data of the file or webpage can be scanned, inspected, or otherwise assessed or analyzed to detect the presence of the reference patch. In an embodiment, such scanning, inspection, analysis, or assessing can take place when the file is opened or before the file is opened. For example, the presence of the reference patch can be detected upon opening a file or directory which contains the file. An entire file or directory (e.g., each file contained therein) can be scanned, inspected, or otherwise assessed or analyzed to detect the presence of a reference patch in each file. In an embodiment, the secondary content corresponding to or indicated by a reference patch can be overlayed when the reference patch is displayed or present in displayed data. For example, in some embodiments, the secondary content corresponding to a reference patch on slide 5 of a slide deck can be overlayed onto displayed data only when slide 5 of that slide deck is displayed. In an embodiment, the reference patch can be detected in the displayed data by a computer vision method described above, a memory vision method as described above, or a combination thereof.

In an embodiment, the presence of the reference patch can be detected upon transferring the file. Such a transfer can be, for example, between different folders and/or directories, between different memory locations, or between different devices. In general, the data can be scanned, inspected, or otherwise assessed or analyzed by any suitable method or technique known to one of ordinary skill in the art. In an embodiment, the presence of the reference patch in the data can be detected on the basis of any suitable piece of data, subset of data, or attribute or combination of attributes thereof. For example, the presence of a reference patch can be detected by the presence of a certain piece of data which has a specific structure or format which corresponds to the reference patch. Such a specific structure or format can be detected with or without accessing or analyzing the data within the specific structure or format. In another example, the presence of a reference patch can be detected by the presence of a signature. In another example, the presence of a reference patch can be detected by a piece of metadata, such as metadata identifying an owner, author, or editor or a program used to create or edit the file. In one embodiment, the metadata can include an access history of the file, the access history including, for example, user access, device access, or program access. The access history of the file can indicate the presence of the reference patch.

For example, the file may have been opened and modified in a graphics program, wherein graphics inserted by the graphics program are reference patches. In an example, the presence of a reference patch can be detected by a pointer, link, or other suitable structure or piece of data which indicates a location associated with the content. The presence of a reference patch can be detected, for example, when the reference patch includes a content location which is a specific website, server, or remote device.

In an embodiment, the presence of a reference patch can be detected upon visiting or loading a website. For example, the presence of the reference patch can be detected in data received from a server which relates to the website. In another example, data indicating the presence of the reference patch can be delivered by a server or other suitable apparatus separately from the data of the website itself. That is, a separate transmission of data indicating the presence of the reference patch can take place at a suitable time. Such a suitable time can be, for example, first accessing the website, logging into an account associated with the website, accessing the website from a specific type of device, or the like.

In an embodiment, the process of detecting the presence of the reference patch can include decoding of certain encoded information in the reference patch. For example, the location address of the secondary content at a local memory location or at a remote device can be decoded. As a part of pre-processing to increase efficiency, the encoded information or a portion thereof can be extracted and decoded when detecting the presence of the reference patch rather than when the reference patch is being displayed in display data. The reference patch itself can retain such encoded information and can retain other encoded information which is not decoded during the detection. In an embodiment, the reference patch can include unencoded data. Such unencoded data can, for example, relate to the location of the secondary content. In an embodiment, the encoded information can, when decoded, point to, reference, or include the unencoded data. Such unencoded data can be useful for detection of the presence of the reference patch in the file or webpage described above.

The presence of a reference patch within a file or webpage can be indicated by an appropriate piece of data associated with the file. In an embodiment, the appropriate piece of data is metadata. In an embodiment, the metadata can include an indicator identifying the presence of one or more reference patches within the file. In an embodiment, the indicator is a flag, a bit, a bit field, an array, a linked list, a record, a union, a tagged union, an object, a tree, a hash-based structure, a register, or other suitable type of data structure. In an embodiment, the indicator can be referenced or found in a separate data structure, such as a lookup table. For example, the indicator can be a key, wherein the key can be associated with a hash stored in a hash table. The hash can indicate the presence of a reference patch and/or provide additional data related to the reference patch, such as encoded or unencoded data. In an embodiment, the indicator can only identify the presence of one or more reference patches, but no other information regarding the reference patch(es) present. In an embodiment, the indicator can refer to the total number of reference patches present in the file. In an embodiment, a separate indicator may be used for each reference patch. Such an indicator used for each reference patch may be the same indicator as the indicator used to indicate that one or more reference patches is present in the file, or may be a different indicator.

The indicator can also indicate more information than the presence of the reference patch. In an embodiment, the indicator can include encoded data (second encoded data) that identifies the reference patch location within the file. For example, in the slide deck example discussed above, the location of the reference patch on slide 5 can be indicated with the indicator. The reference patch location can be any suitable location, general or specific. For example, the indicator can give the location of the reference patch as being on slide 5 or can give the exact location of the reference patch within slide 5 (e.g., near the top-left corner). Such an exact location can be indicated by any suitable scheme or with any suitable data. For example, the reference patch location can be indicated using vector graphics, coordinates, pixel distance from a known location, relative location (e.g., based on display resolution, based on scale), and the like. In an embodiment, the reference patch location can include temporal information. For example, in a video, the reference patch location can indicate a specific time period during which the reference patch is present in the video.

In an embodiment, the indicator can include encoded data that relates to the identity and/or location of the secondary content. For example, the indicator can indicate that the secondary content is a static image, a video, a 3D model, or some other type of media. In an embodiment, the indicator can indicate a data type of the secondary content. In an embodiment, the indicator can indicate a file format of the secondary content. In an embodiment, the indicator can indicate the file size of the secondary content. In an embodiment, the indicator can indicate screen size or other display size of the secondary content. In an embodiment, the indicator can indicate any suitable display parameter associated with the secondary content, such as the color space, compression, resolution, or any combination of these. In an embodiment, the indicator can indicate any suitable non-display parameter or data associated with the secondary content. For example, the indicator can indicate a source of the secondary content, such as a user, organization, device, or geographic location associated with the creation or editing of the secondary content. The indicator can, for example, indicate a specific piece of secondary content. For example, in a slide deck, the reference patch can correspond to a specific graph or plot of information such as a quarterly report. The indicator can indicate that the reference patch corresponds to this quarterly report. The indicator can also indicate that the reference patch corresponds to a specific quarterly report or one chosen from a list, folder, or database based on other attributes such as creation time or edit time.

In an embodiment, the indicator can include encoded data that relates to the location address of the secondary content at a remote device. By pre-supplying the location address, the indicator can increase the speed and efficiency with which the secondary content can be retrieved from the remote device.

Knowledge of the location address of the secondary content at a remote device, for example, can allow for the creation and transmission of a “ready request” to the remote device. Such a request could contain the location address of the secondary content such that the remote device can locate the secondary content and ready it for transmission upon an appropriate signal, such as a “delivery request”. The delivery request can be transmitted to the remote device at an appropriate time, such as when the reference patch becomes displayed in the display data, when the file is opened, or at a specific point when the reference patch will be displayed but is not yet displayed (e.g., when the display is currently displaying slide 4, while the reference patch is on slide 5). The delivery request can be associated with or cause an initiation of a transfer of data associated with the content. This may be advantageous for managing network traffic related to the secondary content. For example, the “ready request” could be used to prioritize or queue outgoing transmissions from the remote device. The separation of the “ready request” and “delivery request” can allow for the remote device to adjust the parameters of the delivery to take advantage of, for example, available computational resources or network bandwidth. A “ready request”, for example, could enable the remote device to divide up one or more large files for delivery. In this way, a large number of simultaneous transfers can take place which deliver the content, which can then be “reassembled”. This can be advantageous for rapid delivery of one or more large files using a limited amount of bandwidth. In this way, no delay in the display or integration of the content occurs. Knowledge of the location address of the secondary content can also allow for pre-retrieving of the secondary content discussed below. Overlaying of the secondary content can happen when the reference patch is displayed.

In an embodiment in which the indicator can indicate the number of reference patches present, the indicator can contain encoded data which corresponds to the reference patch location, the identity of the secondary content, and/or a location address of the secondary content at the remote device for each reference patch. The indicator can indicate such locations, identities, and/or location addresses in any suitable order. For example, in a slide deck, the indicator can include locations for each reference patch in the slide deck in order of the slide on which each reference patch is included. In the example of a video file, the indicator can include locations for each reference patch in order of appearance or the earliest initial visibility. In another example, the indicator can order the reference patches based on the location address of the secondary content at the remote device. In another example, the indicator can order the reference patches based on a creation date, edit date, and/or addition to file date. The creation date can refer to the date and time of creation of the reference patch itself. The edit date can refer to the date and time of the most recent edit to the reference patch itself. The addition to file date can refer to the date and time of the addition or inclusion of the reference patch in the file. Such an addition to file date can be particularly advantageous to include for reference patches which are added to files after the files have been created, for example by editing using an appropriate software.

In an embodiment in which a separate indicator is used for each reference patch, each indicator can contain encoded data which corresponds to the reference patch location, the identity of the secondary content, and/or a location address of the secondary content at the remote device for each reference patch. The indicator can indicate such locations, identities, and/or location addresses in any suitable order as described above.

As the secondary content can be stored on a remote device, it can be advantageous to verify that the secondary content is available at the remote device and to, if applicable, notify a user if the remote device or secondary content is not available. In an embodiment, upon opening a file containing a reference patch and having an indicator, a content check can be performed. The content check can be one or more automatic verifications to verify that the content can be retrieved. For example, upon opening a file having an indicator, if there is no active connection to the remote device or communication network, the content check would fail. A suitable alert or notification can be generated and issued to the user to inform the user that the secondary content cannot be retrieved. In another example, if the secondary content has moved to a different location or been removed from the remote device the content check can fail. Similar to the previous example, a suitable alert or notification can be issued to the user to inform the user that the secondary content is not available at that location. In another example, the content check can involve a permission check. The permission check can verify that the user has the correct permission to access the secondary content. If the user does not have permission to access the secondary content, the content check can fail. Similarly, a suitable notification or alert can be issued to inform the user. Such an alert can be the same for all failed content checks or can be tailored to inform the user based on the reason for the failed content check (e.g., no active connection, content not at that location, incorrect permission to access content, etc.). This content check can be advantageous for informing a user that the reference patches may not work properly due to lack of access to the secondary content and therefore the file may not currently suit the user's needs.

In an embodiment, a failed content check can be visually represented to the user by a suitable content visual indicator. This content visual indicator can be similar to the visual indicator which indicates the presence of the indicator described above. In an embodiment, the content visual indicator can be separate from or displayed in addition to the visual indicator. For example, both could be displayed to indicate to a user that the file has an indicator and the content associated with the reference patch(es) within the file is available. Similarly, a file could have a visual indicator indicating the presence of an indicator and a content visual indicator which indicates that the secondary content associated with the reference patch(es) in the file is not available.

In an embodiment, a passed or failed content check can also be a cause for the indicator to be updated. The updating can be performed as described above. In an instance where the content check fails, for example because the user no longer has permission to access the secondary content, the indicator can be updated to reflect the recent failed content check. Such an update can include a change in the content visual indicator.

In an embodiment, the indicator further includes a last content check log. Such a log can, for example, record the date and time as well as the outcome of the most recent content check.

The knowledge of the location address of the secondary content at a remote device, along with any other suitable information included in an indicator or indicators, can allow for a “pre-retrieval” of the secondary content. Such pre-retrieval is distinct from the retrieval described above in that the pre-retrieval occurs before the reference patch is displayed or is specifically decoded. An appropriate indicator in the data of a file, for instance, can, upon opening the file for example, allow for the generation and transmission of a “pre-retrieval request” to the remote device. The pre-retrieving can involve transmission of the secondary content from the remote device to one or more devices 701-70n. This way, the one or more devices can have the secondary content (or a copy thereof) locally. Such local secondary content can be stored in a suitable memory of the one or more devices. For example, when opening a document which contains a reference patch corresponding to secondary content, the secondary content can be pre-retrieved before the reference patch is displayed in the display data. This way, the secondary content can be retrieved from a local location (i.e., not the remote device) and overlayed on the displayed data when the reference patch is detected and/or identified in the display data, for example by a computer vision technique or a memory vision technique as described above with reference to FIGS. 3A-3C and 4A-4C, respectively. For example, the secondary content can be prepared before the reference patch is displayed and the overlaying can happen only when the reference patch is displayed.

This pre-retrieval can also allow for the use of reference patches without an active connection to the remote device at the time of display of the reference patch. The local storage of pre-retrieved secondary content can enable the use of one or more reference patches so long as there was an active connection to the remote device at the time of pre-retrieval. This can enable a “work offline” mode in which there need not be an active connection to a network or the internet to access secondary content stored on a remote device. This can be advantageous in situations where such an active connection is impractical or impossible. For example, if a business person wanted to work on a document or slide deck which contained a reference patch while on a plane or an emergency responder needed to work on a file on a portable device such as a laptop in a power outage or emergency situation in which there was no active internet, there would be no way to access the secondary content at the remote device when the reference patch is displayed. Often, one does not have prior knowledge of the exact files which will be necessary to open in such a situation. Pre-retrieval and local storage of the secondary content, however, can enable the business person or emergency responder to accomplish their requisite tasks without having to, for example, open the file and leave the file in a configuration in which the reference patch and corresponding/related secondary content is displayed while disconnecting from the network, internet, or remote device.

In an embodiment, the pre-retrieval can be enabled and disabled. That is, a user may select certain files or reference patches to have pre-retrieval enabled or disabled. This “pre-retrieval status” can be indicated or recorded in the indicator. For example, an indicator may further contain information relating to whether the reference patch or patches in the file are to be available in the absence of an active connection to the remote device (e.g., an “available offline” status). In an embodiment, the indicator can be hidden, locked, rendered inactive, or otherwise inaccessible if pre-retrieval is disabled. Such a status may be set on a per-file basis, a per-content basis, a per-reference patch basis, a per-indicator basis, a per-device basis, or any other suitable basis. For example, a user may intend to work on only a portion of a large document which contains multiple reference patches. The portion on which the user intends to work can contain a reference patch, but the document can contain additional reference patches which are not necessary at the time of use. It would be advantageous for a user to only have pre-retrieval active for the reference patch or patches within the portion on which they intend to work. Turning off pre-retrieval for the reference patches in other portions of the document can be advantageous for conserving computing resources or increasing the speed with which the document is prepared and ready for “offline mode”.

In an embodiment, the pre-retrieval can be enabled or disabled automatically. For example, the pre-retrieval can be enabled or disabled based on a factor which is not user input. The pre-retrieval can be configured to be automatically enabled, automatically disabled, or some parameter of the pre-retrieval adjusted based on the network connection of the device. Connecting to a public network, for example, can potentially expose a user, a device, files within a device, or network traffic generated by a device to unwanted surveillance or unwanted access by third parties. The indicator can be configured such that pre-retrieval is disabled when connected to a public network. In an embodiment, the pre-retrieval can be configured to be automatically enabled, automatically disabled, or some parameter of the pre-retrieval adjusted based on a device location. Such a location can be a physical location such as GPS or other location service or a network location, such as an IP address. For example, pre-retrieval can be turned off automatically in sensitive locations such as government or commercial facilities. In another example, pre-retrieval can be turned off to avoid roaming charges on a mobile device such as a smartphone, laptop, or tablet. In an embodiment, the indicator can include a pre-retrieval status. That is, the indicator can indicate if the content has been pre-retrieved previously. Files which are “available offline” which already have content pre-retrieved do not need to have the pre-retrieval repeated. The indicator can be configured to automatically turn off pre-retrieval for content which has already been pre-retrieved and which (or a copy thereof) is stored locally. In an embodiment, a file which is “available offline” as described above can have an indicator which is configured to automatically enable or disable pre-retrieval based on a content check as described above. For example, if a file is “available offline”, pre-retrieval can be disabled. Changes or updates to the content which happen after the pre-retrieval would not be reflected in the version of the content which was already pre-retrieved. A content check can be performed to ensure that the version of the content is the most up-to-date version available and if not, automatically enable pre-retrieval of such updated content.

In an embodiment, the presence of the indicator in the data of a file can be displayed to a user visually. In an embodiment, a visual indicator can be displayed to the user to make such an indication. The visual indicator can be any suitable visual indicator. For example, the visual indicator could be an icon corresponding to the file. Such an icon can be different from an icon which can correspond to a similar file (e.g., of the same type or having the same extension) which does not contain the indicator. In an embodiment, the difference between the icon for a file having an indicator and the icon for a file which does not have the indicator can be any difference detectable by cursory visual inspection by a user. In an embodiment, the difference between the icon for a file having an indicator and the icon for a file which does not have the indicator can be any difference detectable by a device. For example, the difference could be detectable by a computer vision method or a memory vision method as described above, or by any other suitable method. Preferably, the visual indicator allows the user to quickly and easily identify the file type or file extension and the presence of the reference patch. For example, the icon associated with Microsoft Word® documents can be altered slightly if a reference patch is present. The alteration can be small enough that the icon is still recognized as corresponding to a Word® document but large enough to allow a user to easily tell that the specific document contains an indicator. In an embodiment, the visual indicator can involve a change to pixel luma and/or pixel chroma associated with the file or with an icon corresponding to the file which contains an indicator. For example, a glow, highlighting, or other increase in the visibility or attention-drawing aspects can be added to a file or an icon corresponding to a file which contains an indicator. In an embodiment, the visual indicator can involve a pixel luma and/or pixel chroma associated with the file or with an icon corresponding to the file which does not contain an indicator. For example, files which do not contain an indicator can be grayed out or have their brightness diminished to achieve visual indication of the files which do contain an indicator by contrast. In such an example, the files which do contain an indicator would be highlighted as not being grayed out.

In an embodiment, such a visual indicator can be added to a folder or file directory. Such a use of a visual indicator can indicate the presence of one or more files within the folder or file directory which have an indicator.

Similar to the content visual indicator and visual indicator, in an embodiment, a pre-retrieval indicator can be used to visually indicate that secondary content associated with reference patch or patches in the file have been pre-retrieved. The pre-retrieval status of secondary content can be included in the indicator. Such pre-retrieval can cause the indicator to be updated as described above. In an embodiment, the indicator further includes a pre-retrieval log. Such a log can, for example, record the date and time as well as the current status (e.g., local location, availability, etc.) of the pre-retrieved content.

The indicator itself can be any suitable data which can achieve the above structure and/or functionality. In an embodiment, the indicator is a flag, a bit, a bit field, an array, a linked list, a record, a union, a tagged union, an object, a tree, a hash-based structure, a register, or other suitable type of data structure as described above. In an embodiment, the indicator includes one or more data values or variables. The data value(s) can be any suitable type of data value or variable, such as Boolean, integer, floating point, character, sting, enumerated type, array, date, time, datetime, or timestamp. In a simple example, the indicator contains a true/false (or other suitable) variable which denotes the presence/absence of the reference patch in the file. A similar such data value or variable can be used to indicate other data, factors, attributes, or indicators described above which are capable of being represented by such true/false variables (e.g., the pre-retrieval status, presence or absence of visual indicator, “available offline” status, content check pass or failure, etc.). As discussed above, in an embodiment, the indicator contains a data value which is not Boolean. For example, the indicator can contain a data value which corresponds to a number of reference patches in the file. Such a data value can be an integer. In general, there is no limit to the number or type of data values or variables which can be included in the indicator. In an embodiment, the indicator contains a single data value or variable. In an embodiment, each piece of information to be conveyed as described above corresponds to a different indicator. For example, the presence of a reference patch in a file can be indicated by a first indicator, a second indicator can indicate the location of the reference patch in the file, and a third indicator can indicate the location of secondary content. In another example, the presence of one or more reference patches in a file can be indicated by a first indicator, a second indicator can indicate the number of reference patches present in the file, a third indicator can indicate the location of a first reference patch in the file, a fourth indicator can indicate the location of a second reference patch in the file, etc.

In an embodiment, the indicator is a data structure. Such a data structure generally includes data values. The data structure can also include relationships among the data values and/or operations which can be applied to the data values. Examples of types of data structures which the indicator may be include, but are not limited to, a bytestream, an array, a list, a linked list, a record (also called a tuple or struct), a union, a tagged union (also called a variant, variant record, discriminated union, or disjoint union), and an object. In an embodiment, the indicator is a parsable object.

In general, the indicator can be added to the data of any file that contains a reference patch. The indicator can be added using any suitable method known to one of ordinary skill in the art. In an embodiment, the indicator can be added to a file at the same time as a reference patch is added to the file. In an embodiment, the indicator can be generated along with or at the same time as the reference patch is generated. In an embodiment, the indicator can be generated after a reference patch has been added to a file. For example, the indicator can be generated and/or incorporated into the data of a file upon saving the file after the reference patch has been added. The data included in the indicator can, for example, be obtained from detection of the reference patch and/or decoding of the encoded data. Such detection can be performed by computer vision or memory vision as described above. In another example, the indicator can be generated and/or incorporated into the data of a file when the file is closed after adding the reference patch.

In an embodiment, the indicator can be added to a file which already contained a reference patch but did not contain an indicator in the file data. For example, when receiving a file from another party or device, that file may already have a reference patch included. While such a file can have an indicator, it is possible that the file does not have an indicator. It is obviously advantageous to add an indicator to a file which contains a reference patch but does not contain an indicator for future use of the file. Upon detecting the reference patch, for example by computer vision or memory vision as described above, the indicator can be generated or a trigger can be set to generate the indicator upon a certain action, such as saving or closing the file. The indicator can be incorporated into the data of the file upon indicator generation or upon a certain action, such as saving or closing the file. A similar situation can arise when receiving data to be displayed from another party or device. In such an embodiment, the indicator can be added to a file which corresponds to the data to be displayed. Such a file can reside on the other device. That is, the device which detects the reference patch in the displayed data and the device which contained the file corresponding to the displayed data can be different devices. This may be particularly advantageous in situations where the file is stored on a network device, server, in the cloud, or the like or in situations in which the file is transferred or streamed to another device for viewing and/or processing. This may be advantageous for utilizing a device which has more available computational resources for the detection of the reference patch or other step.

In an embodiment, the generation of the indicator can be handled by the generating device described above. That is, the same device which generates the reference patch can generate the indicator. The indicator can be added to, integrated with, appended to, or otherwise introduced into the data by any suitable method. In an embodiment, the indicator can be added to the data using the generating device. In an embodiment, the indicator is added to the data using the operating system. For example, a specific instruction can be created by a software which causes the operating system to add the indicator to the data of the file. Such addition can happen at any suitable time as described above. In an embodiment, the indicator is added to the data using a software which opens, views, edits, uses, or otherwise accesses the file. For example, a .DOC or .DOCX file can be opened, edited, and otherwise handled by Microsoft Word®. In response to the generating of the reference patch, integration of the reference patch into such a .DOC or .DOCX file, or the detection of a reference patch in such a .DOC or .DOCX file, an instruction can be passed to Microsoft Word® (i.e., the application which is handling the file) which instructs Microsoft Word® to add the indicator to the data of the file. Such addition can happen at any suitable time as described above. Such specific instruction can be created and/or passed to the operating system or specific software or application by another software or application or a suitable device or portion of a device, such as a dedicated software or application which carries out the method described herein or by the processing circuitry described herein.

As the reference patch itself or the file which contains the reference patch can be edited, it is advantageous for the indicator to have the ability to be edited or updated. Such edits or updates can reflect changes in the reference patch, such as changes in the location of the reference patch in the file, changes to the secondary content or secondary content address, or any other suitable parameter of the reference patch. In an embodiment, the indicator can be updated by deleting or removing an existing indicator and generating and/or adding a new indicator. Such generation and/or addition can be performed as described above. In an embodiment, the indicator itself or components of the indicator can be updated by editing. Such editing is distinct from the deleting above in that the editing does not involve deletion and replacement, but instead involves changing of certain attributes of the indicator. Such editing can be performed similar to the generation or addition of the indicator as described above. In an embodiment, the indicator can be updated upon any change to the reference patch. In an embodiment, the indicator can be updated automatically upon saving the file including the reference patch. In an embodiment, the indicator can be updated upon closing the file.

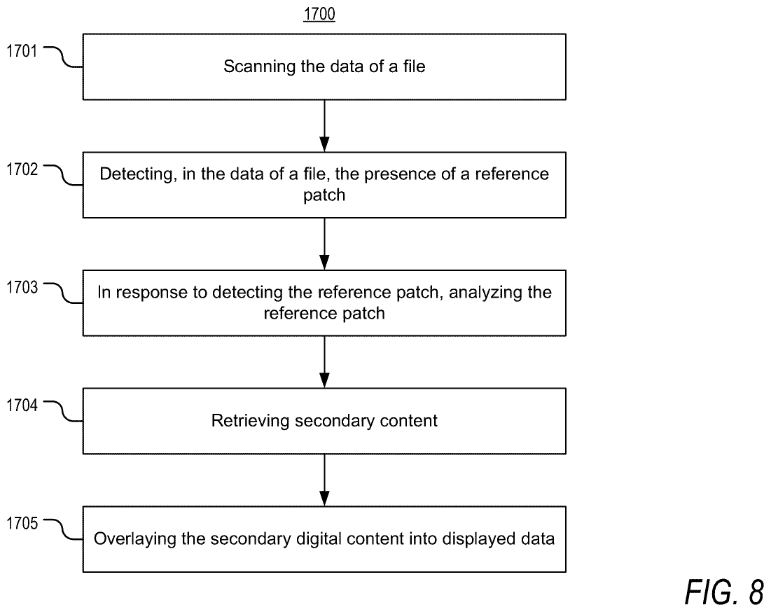

FIG. 8 depicts a flow chart outlining a method of detecting and utilizing an indicator present in a file data, according to an exemplary embodiment of the present disclosure.

The method 1700 comprises step 1701 which involve scanning the data of a file. In general, the accessing can be performed using any suitable technique or with any hardware and/or software known to one of ordinary skill in the art. The scanning can be performed in response to a suitable trigger, such as opening the file, inspecting the file, examining the properties of the file, opening a folder containing the file, and the like.

The method 1700 next involves step 1702 detecting, in the data of the file the presence of a reference patch.

The method 1700 next involves step 1703 in response to detecting the reference patch, identifying and analyzing the reference patch. Such analyzing can involve computer vision as described above, memory vision as described above, a combination of these techniques, or any other suitable such technique.

The method 1700 next involves step 1704 retrieving secondary content. Retrieving can be performed from a remote device as described above or from a local location (e.g., local memory) as described above.

The method 1700 next involves overlaying the secondary content into displayed data as in step 1705. The overlaying may be performed as described above.

Embodiments of the subject matter and the functional operations described in this specification are implemented by processing circuitry (on one or more of devices 701-70n, 850, and 1001), in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of a data processing apparatus/device, (such as the devices of FIG. 1 or the like). The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both or any other kind of central processing unit. Generally, a CPU will receive instructions and data from a read-only memory or a random-access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

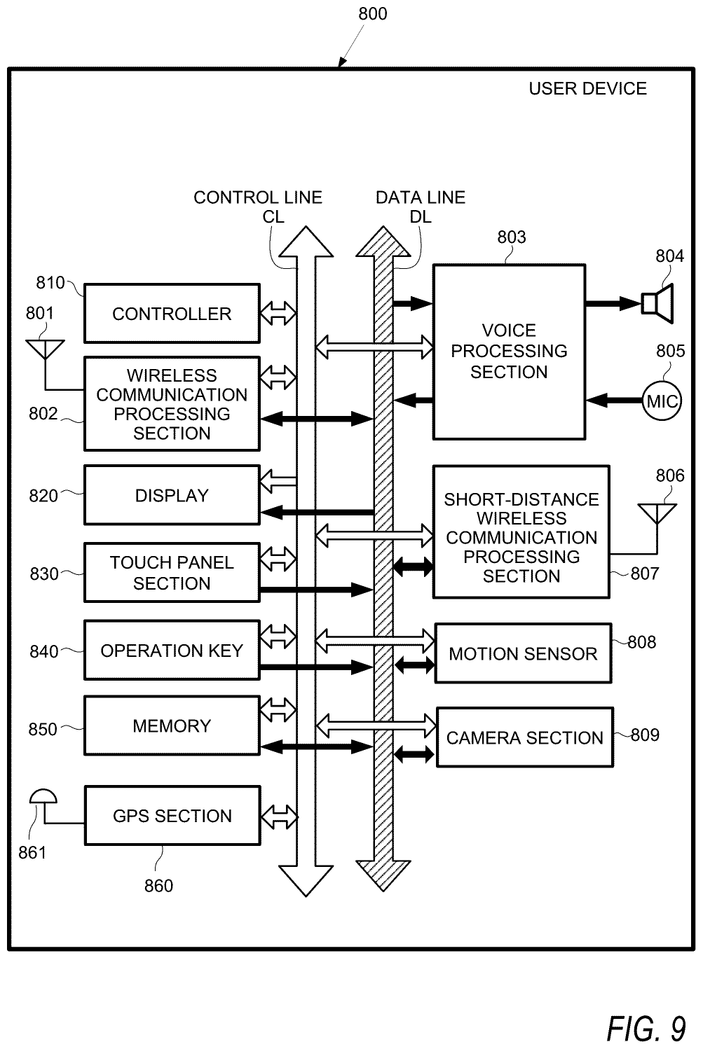

Electronic device 800 shown in FIG. 9 can be an example of one or more of the devices shown in FIG. 1. In an embodiment, the device 800 may be a smartphone. However, the skilled artisan will appreciate that the features described herein may be adapted to be implemented on other devices (e.g., a laptop, a tablet, a server, an e-reader, a camera, a navigation device, etc.). The device 800 of FIG. 9 includes processing circuitry, as discussed above. The processing circuitry includes one or more of the elements discussed next with reference to FIG. 9. The device 800 may include other components not explicitly illustrated in FIG. 9 such as a CPU, GPU, frame buffer, etc. The device 800 includes a controller 810 and a wireless communication processor 802 connected to an antenna 801. A speaker 804 and a microphone 805 are connected to a voice processor 803.

The controller 810 may include one or more processors/processing circuitry (CPU, GPU, or other circuitry) and may control each element in the device 800 to perform functions related to communication control, audio signal processing, graphics processing, control for the audio signal processing, still and moving image processing and control, and other kinds of signal processing. The controller 810 may perform these functions by executing instructions stored in a memory 850. Alternatively, or in addition to the local storage of the memory 850, the functions may be executed using instructions stored on an external device accessed on a network or on a non-transitory computer readable medium.

The memory 850 includes but is not limited to Read Only Memory (ROM), Random Access Memory (RAM), or a memory array including a combination of volatile and non-volatile memory units. The memory 850 may be utilized as working memory by the controller 810 while executing the processes and algorithms of the present disclosure. Additionally, the memory 850 may be used for long-term storage, e.g., of image data and information related thereto.

The device 800 includes a control line CL and data line DL as internal communication bus lines. Control data to/from the controller 810 may be transmitted through the control line CL. The data line DL may be used for transmission of voice data, display data, etc.

The antenna 801 transmits/receives electromagnetic wave signals between base stations for performing radio-based communication, such as the various forms of cellular telephone communication. The wireless communication processor 802 controls the communication performed between the device 800 and other external devices via the antenna 801. For example, the wireless communication processor 802 may control communication between base stations for cellular phone communication.

The speaker 804 emits an audio signal corresponding to audio data supplied from the voice processor 803. The microphone 805 detects surrounding audio and converts the detected audio into an audio signal. The audio signal may then be output to the voice processor 803 for further processing. The voice processor 803 demodulates and/or decodes the audio data read from the memory 850 or audio data received by the wireless communication processor 802 and/or a short-distance wireless communication processor 807. Additionally, the voice processor 803 may decode audio signals obtained by the microphone 805.

The exemplary device 800 may also include a display 820, a touch panel 830, an operation key 840, and a short-distance communication processor 807 connected to an antenna 806. The display 820 may be an LCD, an organic electroluminescence display panel, or another display screen technology. In addition to displaying still and moving image data, the display 820 may display operational inputs, such as numbers or icons which may be used for control of the device 800. The display 820 may additionally display a GUI for a user to control aspects of the device 800 and/or other devices. Further, the display 820 may display characters and images received by the device 800 and/or stored in the memory 850 or accessed from an external device on a network. For example, the device 800 may access a network such as the Internet and display text and/or images transmitted from a Web server.

The touch panel 830 may include a physical touch panel display screen and a touch panel driver. The touch panel 830 may include one or more touch sensors for detecting an input operation on an operation surface of the touch panel display screen. The touch panel 830 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 830 may detect when the stylus approaches/contacts the operation surface of the touch panel display (similar to the case in which a finger is used for the touch operation).

In certain aspects of the present disclosure, the touch panel 830 may be disposed adjacent to the display 820 (e.g., laminated) or may be formed integrally with the display 820. For simplicity, the present disclosure assumes the touch panel 830 is formed integrally with the display 820 and therefore, examples discussed herein may describe touch operations being performed on the surface of the display 820 rather than the touch panel 830. However, the skilled artisan will appreciate that this is not limiting.

For simplicity, the present disclosure assumes the touch panel 830 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 830 may include transparent electrode touch sensors arranged in the X-Y direction on the surface of transparent sensor glass.

The touch panel driver may be included in the touch panel 830 for control processing related to the touch panel 830, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 830 may detect a position of a user's finger around an edge of the display panel 820 (e.g., gripping a protective case that surrounds the display/touch panel). Signals may be transmitted by the touch panel driver, e.g., in response to a detection of a touch operation, in response to a query from another element based on timed data exchange, etc.

The touch panel 830 and the display 820 may be surrounded by a protective casing, which may also enclose the other elements included in the device 800. In an embodiment, a position of the user's fingers on the protective casing (but not directly on the surface of the display 820) may be detected by the touch panel 830 sensors. Accordingly, the controller 810 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 810 may be configured to detect which hand is holding the device 800, based on the detected finger position. For example, the touch panel 830 sensors may detect one or more fingers on the left side of the device 800 (e.g., on an edge of the display 820 or on the protective casing), and detect a single finger on the right side of the device 800. In this exemplary scenario, the controller 810 may determine that the user is holding the device 800 with his/her right hand because the detected grip pattern corresponds to an expected pattern when the device 800 is held only with the right hand.

The operation key 840 may include one or more buttons or similar external control elements, which may generate an operation signal based on a detected input by the user. In addition to outputs from the touch panel 830, these operation signals may be supplied to the controller 810 for performing related processing and control. In certain aspects of the present disclosure, the processing and/or functions associated with external buttons and the like may be performed by the controller 810 in response to an input operation on the touch panel 830 display screen rather than the external button, key, etc. In this way, external buttons on the device 800 may be eliminated in lieu of performing inputs via touch operations, thereby improving watertightness.

The antenna 806 may transmit/receive electromagnetic wave signals to/from other external apparatuses, and the short-distance wireless communication processor 807 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 807.

The device 800 may include a motion sensor 808. The motion sensor 808 may detect features of motion (i.e., one or more movements) of the device 800. For example, the motion sensor 808 may include an accelerometer to detect acceleration, a gyroscope to detect angular velocity, a geomagnetic sensor to detect direction, a geo-location sensor to detect location, etc., or a combination thereof to detect motion of the device 800. In an embodiment, the motion sensor 808 may generate a detection signal that includes data representing the detected motion. For example, the motion sensor 808 may determine a number of distinct movements in a motion (e.g., from start of the series of movements to the stop, within a predetermined time interval, etc.), a number of physical shocks on the device 800 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 810, whereby further processing may be performed based on data included in the detection signal. The motion sensor 808 can work in conjunction with a Global Positioning System (GPS) section 860. The information of the present position detected by the GPS section 860 is transmitted to the controller 810. An antenna 861 is connected to the GPS section 860 for receiving and transmitting signals to and from a GPS satellite.

The device 800 may include a camera section 809, which includes a lens and shutter for capturing photographs of the surroundings around the device 800. In an embodiment, the camera section 809 captures surroundings of an opposite side of the device 800 from the user. The images of the captured photographs can be displayed on the display panel 820. A memory section saves the captured photographs. The memory section may reside within the camera section 809 or it may be part of the memory 850. The camera section 809 can be a separate feature attached to the device 800 or it can be a built-in camera feature.

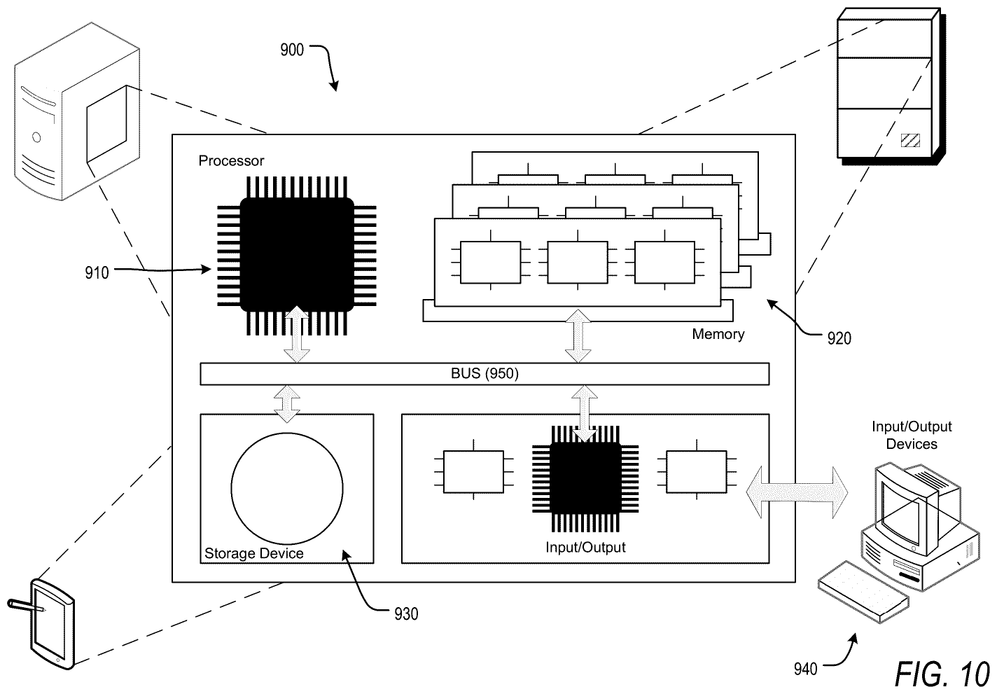

An example of a type of computer is shown in FIG. 10. The computer 900 can be used for the operations described in association with any of the computer-implement methods described previously, according to one implementation. For example, the computer 900 can be an example of devices 701, 702, 70n, 1001, or a server (such as device 850). The computer 900 includes processing circuitry, as discussed above. The device 850 may include other components not explicitly illustrated in FIG. 10 such as a CPU, GPU, frame buffer, etc. The processing circuitry includes one or more of the elements discussed next with reference to FIG. 10. In FIG. 10, the computer 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the computer 900. In one implementation, the memory 920 is a computer-readable medium. In one implementation, the memory 920 is a volatile memory. In another implementation, the memory 920 is a non-volatile memory.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the computer 900. In one implementation, the input/output device 940 includes a keyboard and/or pointing device. In another implementation, the input/output device 940 includes a display for displaying graphical user interfaces.

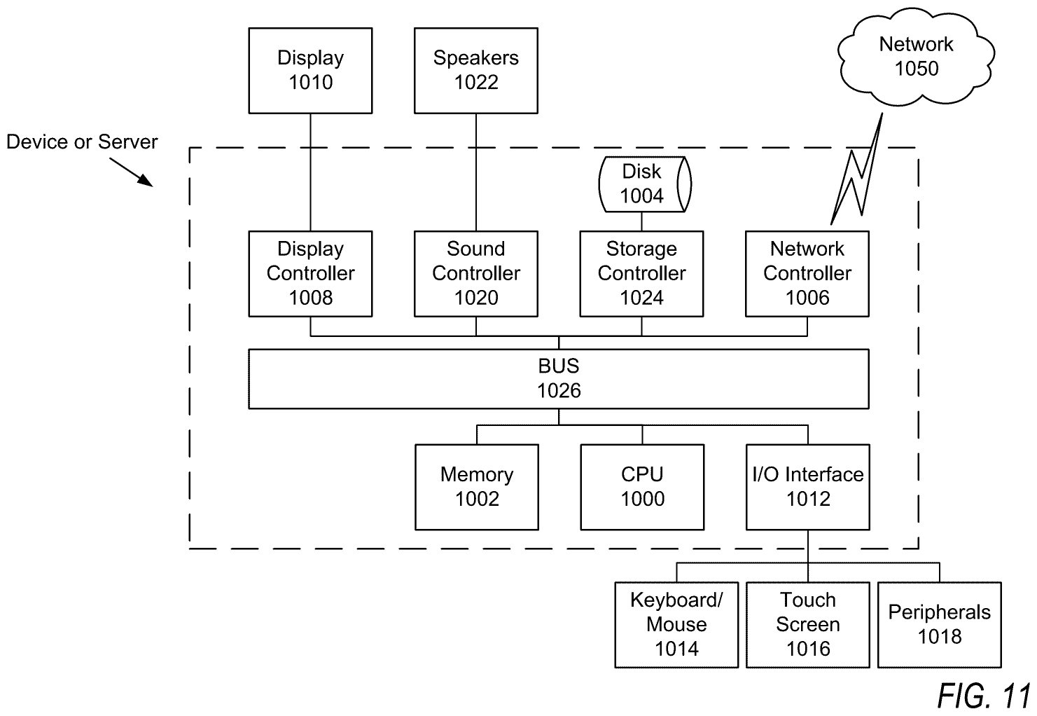

Next, a hardware description of a device according to exemplary embodiments is described with reference to FIG. 11. In FIG. 11, the device, which can be the above described devices of FIG. 1, includes processing circuitry, as discussed above. The processing circuitry includes one or more of the elements discussed next with reference to FIG. 11. The device may include other components not explicitly illustrated in FIG. 11 such as a CPU, GPU, frame buffer, etc. In FIG. 11, the device includes a CPU 1000 which performs the processes described above/below. The process data and instructions may be stored in memory 1002. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 1000 and an operating system such as Microsoft Windows, UNIX, Solaris, LINUX, Apple MAC-OS and other systems known to those skilled in the art.

The hardware elements in order to achieve the device may be realized by various circuitry elements, known to those skilled in the art. For example, CPU 1000 may be a Xenon or Core processor from Intel of America or an Opteron processor from AMD of America, or may be other processor types that would be recognized by one of ordinary skill in the art. Alternatively, the CPU 1000 may be implemented on an FPGA, ASIC, PLD or using discrete logic circuits, as one of ordinary skill in the art would recognize. Further, CPU 1000 may be implemented as multiple processors cooperatively working in parallel to perform the instructions of the processes described above. CPU 1000 can be an example of the CPU illustrated in each of the devices of FIG. 1.

The device in FIG. 11 also includes a network controller 1006, such as an Intel Ethernet PRO network interface card from Intel Corporation of America, for interfacing with the network 1051 (also shown in FIG. 1), and to communicate with the other devices of FIG. 1. As can be appreciated, the network 1051 can be a public network, such as the Internet, or a private network such as an LAN or WAN network, or any combination thereof and can also include PSTN or ISDN sub-networks. The network 1051 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device further includes a display controller 1008, such as a NVIDIA GeForce GTX or Quadro graphics adaptor from NVIDIA Corporation of America for interfacing with display 1010, such as an LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners.

A sound controller 1020 is also provided in the device to interface with speakers/microphone 1022 thereby providing sounds and/or music.

The general-purpose storage controller 1024 connects the storage medium disk 1004 with communication bus 1026, which may be an ISA, EISA, VESA, PCI, or similar, for interconnecting all of the components of the device. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

Obviously, numerous modifications and variations are possible in light of the above teachings. It is therefore to be understood that within the scope of the appended claims, embodiments of the present disclosure may be practiced otherwise than as specifically described herein.

Embodiments of the present disclosure may also be as set forth in the following parentheticals.
(1) An apparatus, comprising processing circuitry, configured to detect, in data of a file, a reference patch that includes a unique identifier associated with an available area in which secondary content is insertable in displayed data that is to be displayed by the apparatus when the reference patch is displayed, the unique identifier including first encoded data that identifies the secondary content, a location address of the secondary content, and a screen position within the available area at which the secondary content is insertable in the displayed data; and in response to detecting the reference patch, retrieve the secondary content based on the unique identifier, and after retrieving the secondary content and when the reference patch is displayed, overlay the secondary content onto the displayed data in accordance with the available area and the screen position identified by the unique identifier.
   (2) The apparatus of (1), wherein an indicator includes second encoded data that that identifies the secondary content and identifies a location address of the secondary content at a remote device and/or a location local to the apparatus.
(3) The apparatus of (2), wherein the processing circuitry is configured to in response to detecting the indicator and the location address of the secondary content being at a remote device, transmit to the remote device a ready request.
(4) The apparatus of any one of (2) to (3), wherein the indicator includes second encoded data that identifies a reference patch location within the file.
(5) The apparatus of any one of (2) to (4), wherein the processing circuitry is configured to in response to detecting the indicator and the location address of the secondary content being at a remote device, pre-retrieve the secondary content from the remote device before the reference patch is displayed by the apparatus.
(6) The apparatus of (5), wherein the pre-retrieving the secondary content involves transmission of a delivery request to the remote device.
(7) The apparatus of any one of (1) to (6), wherein the processing circuitry is configured to perform a content check to detect, in the data of the file, the reference patch, wherein the content check determines whether the secondary content is available at the remote device and/or a location local to the apparatus.
(8) The apparatus of (3), wherein the processing circuitry is configured to in response to a determination by the content check that the secondary content is not available, generate an alert indicating a failed content check.
(9) The apparatus of any one of (1) to (8), wherein the processing circuitry is configured to detect, in other files in a folder or a directory which contain the file, the reference patch.
(10) A method for a device, comprising detecting, in data of a file, a reference patch that includes a unique identifier associated with an available area in which secondary content is insertable in displayed data that is to be displayed by a display when the reference patch is displayed, the unique identifier including first encoded data that identifies the secondary content, a location address of the secondary content, and a screen position within the available area at which the secondary content is insertable in the displayed data; and in response to detecting the reference patch, retrieving the secondary content based on the unique identifier, and after retrieving the secondary content and when the reference patch is displayed, overlaying the secondary content onto the displayed data in accordance with the available area and the screen position identified by the unique identifier.
(11) The method of (10), wherein an indicator includes second encoded data that identifies the secondary content and identifies a location address of the secondary content at a remote device and/or a location local to the device.
(12) The method of (11), further comprising in response to detecting the indicator and the location address of the secondary content being at a remote device, transmitting to the remote device a ready request if the secondary content is in the remote device.
(13) The method of any one of (11) to (12), wherein the indicator includes second encoded data that identifies a reference patch location within the file.
(14) The method of any one of (11) to (13), further comprising in response to detecting the indicator and the location address of the secondary content being at a remote device, pre-retrieving the secondary content from the remote device before the reference patch is displayed by the display.
(15) The method of (14), wherein the pre-retrieving the secondary content involves transmitting a delivery request to the remote device.
(16) The method of any one of (10) to (15), further comprising performing a content check to detect, in the data of the file, the reference patch, wherein the content check determines whether the secondary content is available at the remote device and/or a location local to the device.
(17) The method of (16), further comprising in response to a determination by the content check that the secondary content is not available, generate an alert indicating a failed content check.
(18) The method of any one of (10) to (17), further comprising detecting, in another file in a folder or directory which contain the file, the reference patch.
(19) A non-transitory computer-readable storage medium for storing computer-readable instructions that, when executed by a computer, cause the computer to perform a method, the method comprising: detecting, in data of a file, a reference patch that includes a unique identifier associated with an available area in which secondary content is insertable in displayed data that is to be displayed by a display when the reference patch is displayed, the unique identifier including first encoded data that identifies the secondary content, a location address of the secondary content, and a screen position within the available area at which the secondary content is insertable in the displayed data; and in response to detecting the reference patch, retrieving the secondary content based on the unique identifier, and after retrieving the secondary content and when the reference patch is displayed, overlaying the secondary content onto the displayed data in accordance with the available area and the screen position identified by the unique identifier.
(20) The non-transitory computer-readable storage medium of (19), wherein the method further comprises performing a content check to detect, in the data of the file, the reference patch, wherein the content check determines whether the secondary content is available at the remote device and/or a location local to the computer.
(21) The non-transitory computer-readable storage medium of any one of (19) to (20), wherein an indicator includes second encoded data that identifies the secondary content and identifies a location address of the secondary content at a remote device and/or a location local to the computer.
(22) The non-transitory computer-readable storage medium of (21), wherein the method further comprises in response to detecting the indicator and the location address of the secondary content being at a remote device, transmitting to the remote device a ready request if the secondary content is in the remote device.
(23) The non-transitory computer-readable storage medium of any one of (21) to (22), wherein the indicator includes second encoded data that identifies a reference patch location within the file.
(24) The non-transitory computer-readable storage medium of any one of (21) to (23), wherein the method further comprises, in response to detecting the indicator and the location address of the secondary content being at a remote device, pre-retrieving the secondary content from the remote device before the reference patch is displayed by the apparatus.
(25) The non-transitory computer-readable storage medium of any one of (21) to (24), wherein the pre-retrieving the secondary content involves transmitting a delivery request to the remote device.
(26) The non-transitory computer-readable storage medium of (20), wherein the method further comprises in response to a determination by the content check that the secondary content is not available, generate an alert indicating a failed content check.
(27) The non-transitory computer-readable storage medium of any one of (19) to (26), wherein the method further comprises detecting, in another file in a folder or directory which contain the file, the reference patch.
(28) An apparatus, comprising processing circuitry, configured to detect, in data of a file, a reference patch that includes a unique identifier associated with an available area in which secondary content is insertable in displayed data that is to be displayed by the apparatus when the reference patch is displayed, the unique identifier including first encoded data that identifies the secondary content, a location address of the secondary content, and a screen position within the available area at which the secondary content is insertable in the displayed data, and in response to detecting the reference patch, retrieve the secondary content based on the unique identifier, and after retrieving the secondary content, overlay the secondary content onto the displayed data in accordance with the available area and the screen position identified by the unique identifier.
While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. An apparatus, comprising:
processing circuitry configured to
detect, in data of a file, a reference patch that includes a unique identifier associated with an available area in which secondary content is insertable in displayed data that is to be displayed by the apparatus when the reference patch is displayed, the unique identifier including first encoded data that identifies the secondary content, a location address of the secondary content, and a screen position within the available area at which the secondary content is insertable in the displayed data; and
in response to detecting the reference patch,
retrieve the secondary content based on the unique identifier, and
after retrieving the secondary content and when the reference patch is displayed, overlay the secondary content onto the displayed data in accordance with the available area and the screen position identified by the unique identifier.

2. The apparatus of claim 1, wherein an indicator includes second encoded data that identifies the secondary content and a location address of the secondary content at a remote device and/or a location local to the apparatus.

3. The apparatus of claim 2, wherein the processing circuitry is configured to in response to detecting the indicator and the location address of the secondary content being at a remote device, transmit to the remote device a ready request.

4. The apparatus of claim 2, wherein the indicator includes second encoded data that identifies a reference patch location within the file.

5. The apparatus of claim 2, wherein the processing circuitry is configured to in response to detecting the indicator and the location address of the secondary content being at a remote device, pre-retrieve the secondary content from the remote device before the reference patch is displayed by the apparatus.

6. The apparatus of claim 5, wherein the pre-retrieving the secondary content involves transmission of a delivery request to the remote device.

7. The apparatus of claim 1, wherein the processing circuitry is configured to perform a content check to detect, in the data of the file, the reference patch, wherein the content check determines whether the secondary content is available at a remote device and/or a location local to the apparatus.

8. The apparatus of claim 7, wherein the processing circuitry is configured to in response to a determination by the content check that the secondary content is not available, generate an alert indicating a failed content check.

9. The apparatus of claim 1, wherein the processing circuitry is configured to detect, in other files in a folder or a directory which contain the file, the reference patch.

10. A method for a device, comprising:
detecting, in data of a file, a reference patch that includes a unique identifier associated with an available area in which secondary content is insertable in displayed data that is to be displayed by a display when the reference patch is displayed, the unique identifier including first encoded data that identifies the secondary content, a location address of the secondary content, and a screen position within the available area at which the secondary content is insertable in the displayed data; and
in response to detecting the reference patch,
retrieving the secondary content based on the unique identifier, and
after retrieving the secondary content and when the reference patch is displayed, overlaying the secondary content onto the displayed data in accordance with the available area and the screen position identified by the unique identifier.

11. The method of claim 10, wherein an indicator includes second encoded data that identifies the secondary content and identifies a location address of the secondary content at a remote device and/or a location local to the device.

12. The method of claim 11, further comprising in response to detecting the indicator and the location address of the secondary content being at a remote device, transmitting to the remote device a ready request if the secondary content is in the remote device.

13. The method of claim 11, wherein the indicator includes second encoded data that identifies a reference patch location within the file.

14. The method of claim 11, further comprising in response to detecting the indicator and the location address of the secondary content being at a remote device, pre-retrieving the secondary content from the remote device before the reference patch is displayed by the display.

15. The method of claim 14, wherein the pre-retrieving the secondary content involves transmitting a delivery request to the remote device.

16. The method of claim 10, further comprising performing a content check to detect, in the data of the file, the reference patch, wherein the content check determines whether the secondary content is available at a remote device and/or a location local to the device.

17. The method of claim 16, further comprising in response to a determination by the content check that the secondary content is not available, generate an alert indicating a failed content check.

18. The method of claim 10, further comprising detecting, in another file in a folder or directory which contain the file, the reference patch.

19. A non-transitory computer-readable storage medium for storing computer-readable instructions that, when executed by a computer, cause the computer to perform a method, the method comprising:
detecting, in data of a file, a reference patch that includes a unique identifier associated with an available area in which secondary content is insertable in displayed data that is to be displayed by a display when the reference patch is displayed, the unique identifier including first encoded data that identifies the secondary content, a location address of the secondary content, and a screen position within the available area at which the secondary content is insertable in the displayed data; and
in response to detecting the reference patch,
retrieving the secondary content based on the unique identifier, and
after retrieving the secondary content and when the reference patch is displayed, overlaying the secondary content onto the displayed data in accordance with the available area and the screen position identified by the unique identifier.

20. The non-transitory computer-readable storage medium of claim 19, wherein the method further comprises performing a content check to detect, in the data of the file, the reference patch, wherein the content check determines whether the secondary content is available at a remote device and/or a location local to the computer.
